(19) United States
(12) Patent Application Publication
(10) Pub. No.: US 2024/0073895 A1
(43) Pub. Date: Feb. 29, 2024

(54) METHODS, COMMUNICATIONS DEVICES, AND INFRASTRUCTURE EQUIPMENT

(71) Applicant: Sony Group Corporation, Tokyo (JP)

(72) Inventors: Shin Horng WONG, Basingstoke (GB); Martin Warwick BEALE, Basingstoke (GB); Yassin Aden AWAD, Basingstoke (GB)

(73) Assignee: Sony Group Corporation, Tokyo (JP)

(21) Appl. No.: 18/270,511

(22) PCT Filed: Dec. 14, 2021
(86) PCT No.: PCT/EP2021/085779

§ 371 Date: Jun. 30, 2023

(30) Foreign Application Priority Data
Jan. 11, 2021 (EP) 21151010.2

(51) Int. Cl. H04W 72/1273; H04L 5/00; H04W 72/11; H04W 72/231

(52) U.S. Cl. CPC H04W 72/1273; H04L 5/0053; H04W 72/11; H04W 72/231

(57) ABSTRACT

A method of operating a communications device configured to transmit signals to and/or to receive signals from a wireless communications network via a wireless radio interface provided by the wireless 5 communications network is provided. The method comprises receiving, from the wireless communications network, signals on one or more downlink channels, each of the downlink channels being within one of a plurality of downlink transmission occasions, determining, for each of the downlink channels, whether or not the signals have been successfully received by the communications device, and transmitting, to the wireless communications network, an uplink control channel comprising an acknowledgement number indication, wherein the acknowledgement number indication indicates the number of the downlink transmission occasions within which the communications device determines that the signals were successfully received on one of the downlink channels.

### BACKGROUND

### Field of Disclosure

The present disclosure relates to communications devices, infrastructure equipment and methods for the transmission of data by a communications device in a wireless communications network.

The present invention claims the Paris Convention priority from European patent application number EP21151010.2, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is Enhanced Mobile Broadband (eMBB) services, which are characterised by a high capacity with a requirement to support up to 20 Gb/s. URLLC and eMBB type services therefore represent challenging examples for both LTE type communications systems and 5G/NR communications systems.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

Embodiments of the present technique can provide a method of operating a communications device configured to transmit signals to and/or to receive signals from a wireless communications network via a wireless radio interface provided by the wireless communications network. The method comprises receiving, from the wireless communications network, signals on one or more downlink channels, each of the downlink channels being within one of a plurality of downlink transmission occasions, determining, for each of the downlink channels, whether or not the signals have been successfully received by the communications device, and transmitting, to the wireless communications network, an uplink control channel comprising an acknowledgement number indication, wherein the acknowledgement number indication indicates the number of the downlink transmission occasions within which the communications device determines that the signals were successfully received on one of the downlink channels.

Further embodiments of the present technique can provide a method of operating an infrastructure equipment forming part of a wireless communications network configured to transmit signals to and/or to receive signals from a communications device via a wireless radio interface provided by the wireless communications network. The method comprises transmitting, to the communications device, signals on one or more downlink channels, each of the downlink channels being within one of a plurality of downlink transmission occasions, determining whether the number of downlink channels on which the signals are transmitted exceeds a threshold number, and, if the number of downlink channels on which the signals are transmitted exceeds the threshold number retransmitting, to the communications device, the signals on at least one of the downlink channels.

Yet further embodiments of the present technique can provide a method of operating a communications device configured to transmit signals to and/or to receive signals from a wireless communications network via a wireless radio interface provided by the wireless communications network. The method comprises receiving, from the wireless communications network, signals on one or more downlink channels, each of the downlink channels being within one of a plurality of downlink transmission occasions, determining, for each of the downlink channels, whether or not the signals have been successfully received by the communications device, and receiving, from the wireless communications network, an indication of the number of the one or more downlink channels on which the signals either have been or will be received.

Embodiments of the present technique, which, in addition to methods of operating communications devices and methods of operating infrastructure equipment, relate to communications devices and infrastructure equipment, and circuitry for communications devices and infrastructure equipment, allow for more efficient use of radio resources by a communications device.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 illustrates how multiple Hybrid Automatic Repeat Request Acknowledgement (HARQ-ACK) feedback indications may be multiplexed onto a single Physical Uplink Control Channel (PUCCH);

FIG. 5 illustrates how a PUCCH Resource Indicator may be used to indicate onto which PUCCH HARQ-ACK feedback indications may be multiplexed;

FIG. 6 shows an example of sub-slot based PUCCHs;

FIG. 7 illustrates how multiple HARQ-ACK feedback indications for Semi-Persistent Scheduling (SPS) Physical Downlink Shared Channels (PDSCHs) may be multiplexed onto a single PUCCH per sub-slot;

FIG. 8 shows an example of a jitter time window;

FIG. 9 shows an example of how SPS can be over-configured to compensate for jittering traffic;

FIG. 10 shows an example of how gaps may be implemented between SPS instances within a jitter time window;

FIG. 11 shows an example of how the use of multiple SPS instances within a jitter time window may result in excessive HARQ-ACK feedback indications;

FIG. 12 shows a first example of HARQ-ACK bundling for multiple SPS instances using a logical “OR” operator;

FIG. 13 shows a second example of HARQ-ACK bundling for multiple SPS instances using a logical “OR” operator in which PDSCHs are transmitted in two of the SPS instances;

FIG. 14 shows a part schematic, part message flow diagram representation of a first wireless communications system comprising a communications device and an infrastructure equipment in accordance with embodiments of the present technique;

FIG. 15 illustrates how a UE may indicate the number of ACKs within an SPS group in accordance with embodiments of the present technique;

FIG. 16 illustrates how an SPS group may be implicitly indicated using K₁ values in accordance with embodiments of the present technique;

FIG. 17 illustrates how different subsets of numbers of ACKs may be implicitly indicated using different PUCCH resources in accordance with embodiments of the present technique;

FIG. 18 illustrates how a DCI may be used to activate or deactivate the UE providing the number of ACKs within an SPS group rather than providing individual ACKs/NACKs for each SPS instance in accordance with embodiments of the present technique;

FIG. 19 shows a flow diagram illustrating a first process of communications in a communications system in accordance with embodiments of the present technique;

FIG. 20 shows a part schematic, part message flow diagram representation of a second wireless communications system comprising a communications device and an infrastructure equipment in accordance with embodiments of the present technique;

FIG. 21 shows a flow diagram illustrating a second process of communications in a communications system in accordance with embodiments of the present technique;

FIG. 22 shows a part schematic, part message flow diagram representation of a third wireless communications system comprising a communications device and an infrastructure equipment in accordance with embodiments of the present technique;

FIG. 23 illustrates how a gNB may indicate the number of PDSCHs it transmits to the UE in accordance with embodiments of the present technique; and

FIG. 24 shows a flow diagram illustrating a third process of communications in a communications system in accordance with embodiments of the present technique.

### DETAILED DESCRIPTION OF THE EMBODIMENTS

Long Term Evolution Advanced Radio Access Technology (4G)

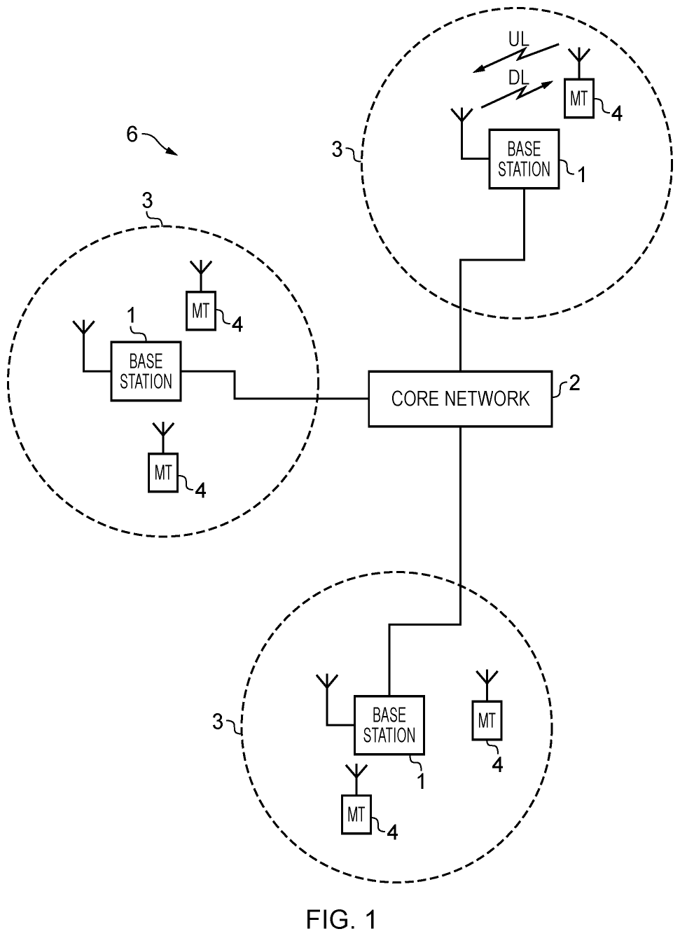

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

New Radio Access Technology (5G)

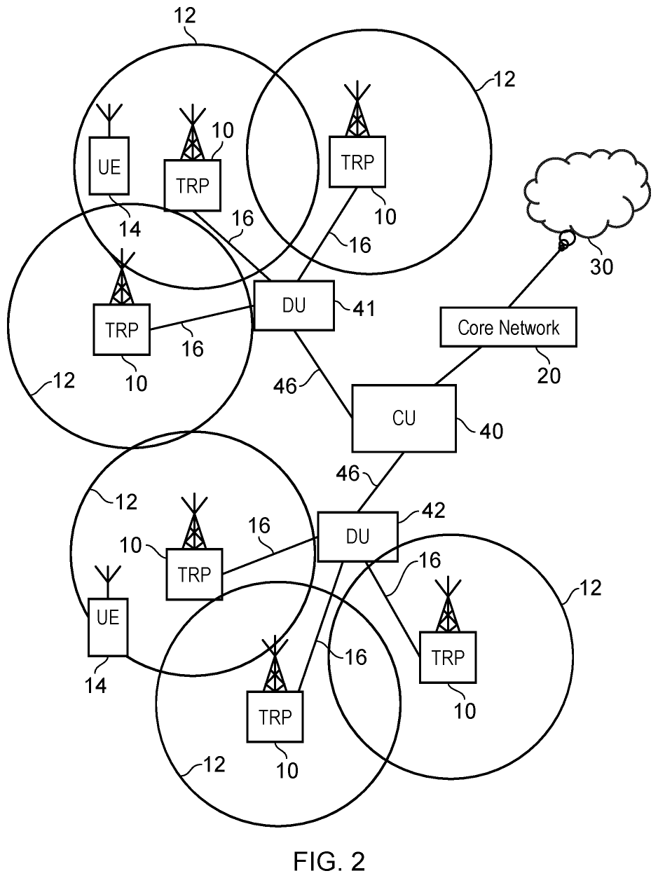

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

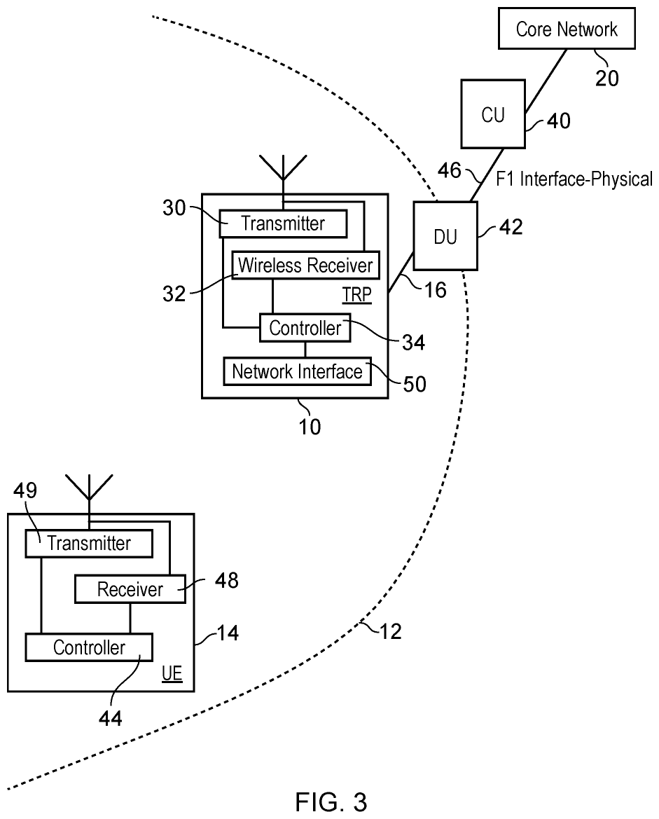

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

eURLLC and eMBB

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [2].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3] specifies features that require high reliability and low latency, such as factory automation, transport industry, electrical power distribution, etc. in a 5G system. eURLLC is further enhanced as IIoT-URLLC [4], for which one of the objectives is to enhance UE feedback for Hybrid Automatic Repeat Request Acknowledgements (HARQ-ACK) for Physical Downlink Shared Channel (PDSCH) transmissions.

PDSCH HARQ-ACK Feedback

In a Dynamic Grant PDSCH (DG-PDSCH), the PDSCH resource is dynamically indicated by the gNB using a DL Grant carried by Downlink Control Information (DCI) in a Physical Downlink Control Channel (PDCCH).

A PDSCH is transmitted using HARQ transmission, where for a PDSCH ending in slot n, the corresponding Physical Uplink Control Channel (PUCCH) carrying the HARQ-ACK is transmitted in slot n+K₁. Here, in Dynamic Grant PDSCH, the value of K₁ is indicated in the field “PDSCH-to-HARQ_feedback timing indicator” of the DL Grant (carried by DCI Format 1_0, DCI Format 1_1 or DCI Format 1_2). Multiple (different) PDSCHs can point to the same slot for transmission of their respective HARQ-ACKs, and these HARQ-ACKs (in the same slot) are multiplexed into a single PUCCH. Hence, a PUCCH can contain multiple HARQ-ACKs for multiple PDSCHs.

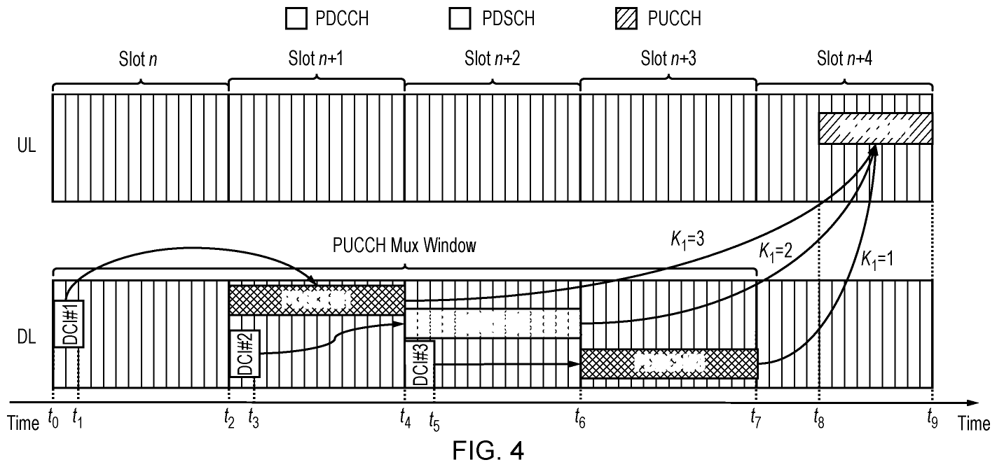

An example of this is shown in FIG. 4, where three DL Grants are transmitted to the UE via DCI #1, DCI #2 and DCI #3 in slot n, n+1 and n+2 respectively. DCI #1, DCI #2 and DCI #3 schedule PDSCH #1, PDSCH #2 and PDSCH #3 respectively. DCI #1, DCI #2 and DCI #3 further indicate K₁=3, K₁=2 and K₁=1 respectively. Since the K₁ values indicate that the HARQ-ACK feedback for PDSCH #1, PDSCH #2 and PDSCH #3 are all to be transmitted in slot n+4, the UE multiplexes all of these HARQ-ACKs into a single PUCCH, i.e. PUCCH #1. The PUCCH Multiplexing Window is a time window where PDSCHs can be multiplexed into that single PUCCH, and the size of the PUCCH multiplexing window depends on the range of K₁ values. In the example in FIG. 4, the PUCCH Multiplexing Window is from Slot n to Slot n+3 (i.e. between time t₀ and time t₇), which means the max K₁ value is 4 slots.

In Rel-15, only one PUCCH per slot is allowed to carry HARQ-ACKs for the same UE, even if the different PUCCHs do not overlap in time. The PUCCH resource is indicated in the “PUCCH Resource Indicator” (PRI) field in the DL Grant. Each DL Grant may indicate a different PUCCH resource, but the UE will follow the PRI indicated in the last PDSCH in the PUCCH Multiplexing Window since the UE only knows the total number of HARQ-ACK bits after the last PDSCH is received.

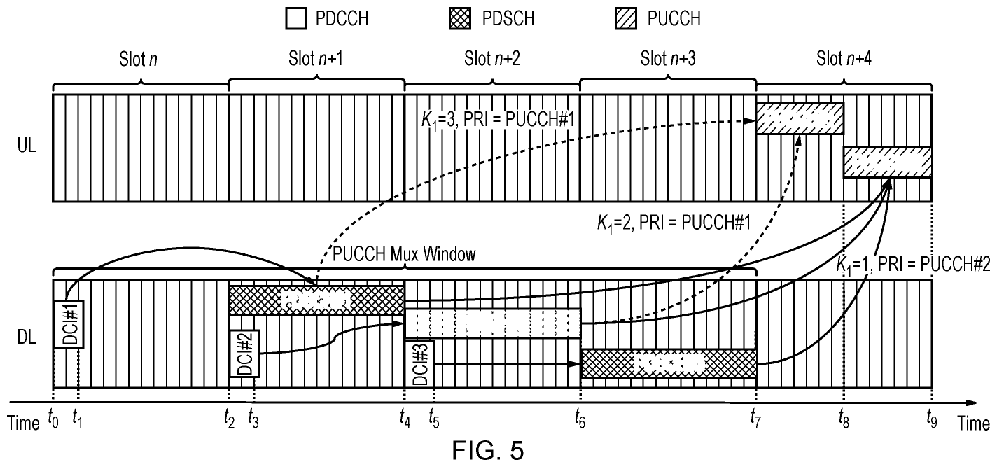

An example of this is shown in FIG. 5, where DCI #1 and DCI #2 indicate PUCCH #1 for the HARQ-ACKs corresponding to PDSCH #1 and PDSCH #2, but DCI #3 indicates PUCCH #2 for the HARQ-ACK corresponding to PDSCH #3. Here, PUCCH #1 and PUCCH #2 do not overlap in time. Since DCI #3 schedules the last PDSCH, i.e. PDSCH #3, in the Multiplexing Window, the UE will use PUCCH #2 to carry the HARQ-ACKs for PDSCH #1, PDSCH #2 and PDSCH #3. It should be noted here that a PUCCH carrying other UCI such as SR (Scheduling Request) can be transmitted separately to a PUCCH carrying HARQ-ACKs within the same slot if they do not overlap in time.

In Rel-16 eURLLC, sub-slot PUCCH is introduced for carrying HARQ-ACKs for URLLC PDSCHs. Sub-slot based PUCCHs allow more than one PUCCH carrying HARQ-ACKs to be transmitted within a slot. This gives more opportunity for PUCCHs carrying HARQ-ACKs for PDSCHs to be transmitted within a slot, thereby reducing latency for HARQ-ACK feedback. In a sub-slot based PUCCH, the granularity of the K₁ parameter (i.e. the time difference between the end of a PDSCH and the start of its corresponding PUCCH) is in units of sub-slots instead of units of slots, where the sub-slot size can be either two symbols or seven symbols.

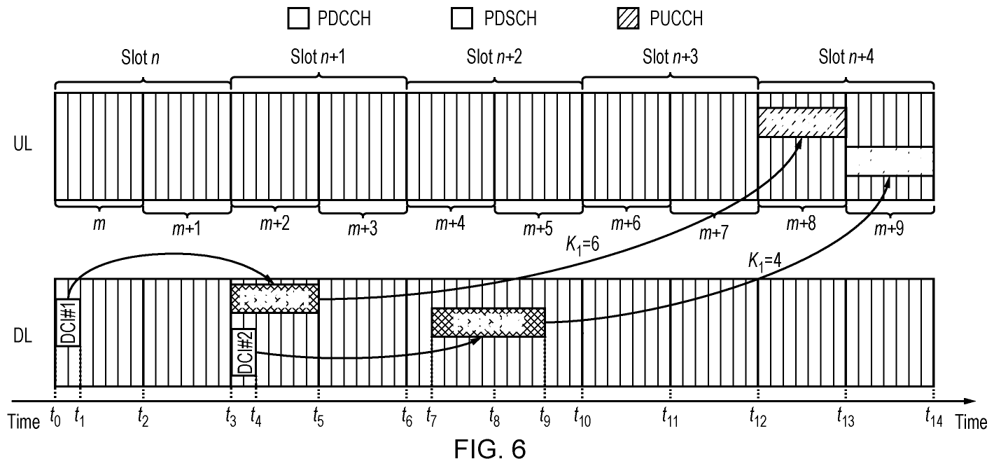

An example of this is shown in FIG. 6, where the sub-slot size equals seven symbols (i.e. half a slot) and the sub-slots are labelled as m, m+1, m+2, etc. PDSCH #1 is transmitted in slot n+1 but for sub-slot based HARQ-ACK PUCCH, it is considered to be transmitted in sub-slot m+2 and here K₁=6 which means that the corresponding HARQ-ACK is in sub-slot m+2+K₁=m+8. PDSCH #2 is transmitted in slot n+2 but occupies sub-slots m+4 and m+5. The reference for K₁ is relative to the sub-slot where the PDSCH ends, and in this case PDSCH #2 ends in sub-slot m+5. The DL Grant in DCI #2 that schedules PDSCH #2 indicates K₁=4, which schedules a PUCCH for its HARQ-ACK at sub-slot m+5+K₁=sub-slot m+9.

Semi-Persistent Scheduling (SPS)

As is well understood by those skilled in the art, a gNB uses a PDSCH for downlink data transmission to a UE. The PDSCH resources used for the transmission of the PDSCH can be scheduled by a gNB either dynamically, or through the allocation of Semi-Persistent Scheduling (SPS) resources.

Similarly to the use of Configured Grants (CGs) in the uplink, the use of SPS in the downlink reduces latency, particularly for regular and periodic traffic. The gNB is required to explicitly activate and deactivate SPS resources when it determines they may be required. These SPS resources are typically configured via Radio Resource Control (RRC) signalling, and occur periodically where each SPS PDSCH occasion has a pre-configured and fixed duration. This allows the gNB to schedule traffic that has a known periodicity and packet size. The gNB may or may not transmit any PDSCH in any given SPS PDSCH occasion, and so the UE is required to monitor each SPS PDSCH occasion for a potential PDSCH transmission.

In Rel-15 the UE can only be configured with one SPS PDSCH and this SPS PDSCH is activated using an activation DCI (Format 1_0 or 1_1) with the Cyclic Redundancy Code (CRC) scrambled with a Configured Scheduling Radio Network Temporary Identifier (CS-RNTI). Once an SPS PDSCH is activated, the UE will monitor for a potential PDSCH in each SPS PDSCH occasion of the SPS PDSCH configuration without the need for any DL Grant until the SPS PDSCH is deactivated. Deactivation of the SPS PDSCH is indicated via a deactivation DCI scrambled with CS-RNTI. The UE provides a HARQ-ACK feedback for the deactivation DCI, but no HARQ-ACK feedback is provided for an activation DCI.

Similar to DG-PDSCH, the slot containing the PUCCH resource for HARQ-ACK corresponding to SPS PDSCH is indicated using the K₁ value in the field “PDSCH-to-HARQ_feedback timing indicator” of the activation DCI. Since a dynamic grant is not used for SPS PDSCH, this K₁ value is applied for every SPS PDSCH occasion, and can only be updated after it has been deactivated and re-activated using another activation DCI with a different K₁ value.

Since there is only one SPS PDSCH, PUCCH Format 0 or 1 is used to carry the HARQ-ACK feedback. If the PUCCH collides with a PUCCH carrying HARQ-ACK feedback for a DG-PDSCH, the HARQ-ACK for SPS PDSCH is multiplexed into the PUCCH corresponding to the DG-PDSCH.

In Rel-16 the UE can be configured with up to eight SPS PDSCHs, where each SPS PDSCH has an SPS Configuration Index that is RRC configured. Each SPS PDSCH is individually activated using a DCI (Format 1_0, 1_1 & 12) with the CRC scrambled with CS-RNTI, where the DCI indicates the SPS Configuration Index of the SPS PDSCH to be activated. However, multiple SPS PDSCHs can be deactivated using a single deactivation DCI. Similar to Rel-15, the UE provides a HARQ-ACK feedback for the deactivation DCI, but does not provide one for the activation DCI.

The slot or sub-slot containing the PUCCH resource for HARQ-ACK feedback corresponding to an SPS PDSCH occasion is determined using the K₁ value indicated in the activation DCI. Since each SPS PDSCH configuration is individually activated, different SPS PDSCH can be indicated with different K₁ values.

Since different K₁ values can be used for different SPS PDSCH configurations, it is possible that the HARQ-ACK for multiple SPS PDSCHs point to the same slot or sub-slot, and in such a scenario, these HARQ-ACKs are multiplexed into a single PUCCH. For multiple SPS PDSCH configurations, PUCCH Format 2, 3 & 4 (in addition to PUCCH Format 0 & 1) can be used to carry multiple HARQ-ACKs for SPS PDSCH. Here, the HARQ-ACKs in the PUCCH are sorted in ascending order according to the DL slot for each of the SPS PDSCH Configuration Indices, and then sorted in ascending order of SPS PDSCH Configuration Index. It should be noted here that since typically the K₁ value is fixed per SPS PDSCH then it is unlikely to have two or more SPS PDSCH with the same index being multiplexed into a PUCCH.

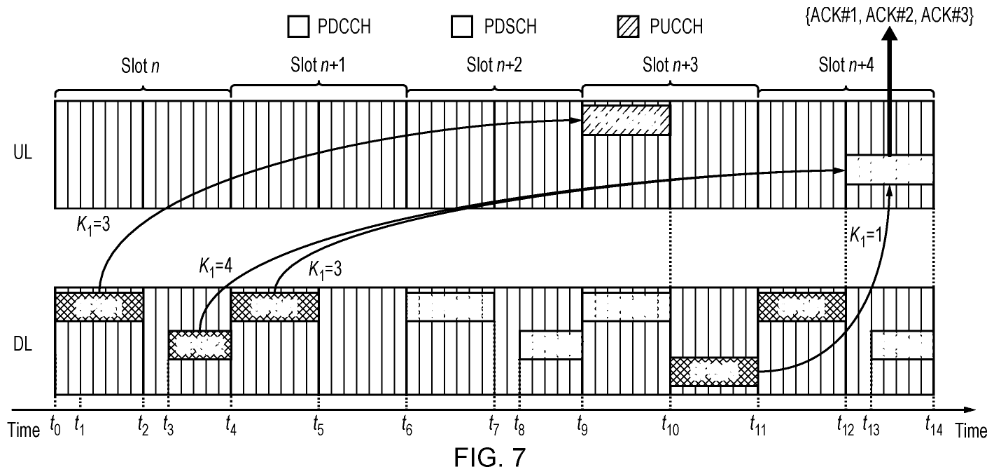

An example of this is shown in FIG. 7, where a UE is configured with three SPS PDSCHs labelled as SPS #1, SPS #2 and SPS #3 with different periodicities that are RRC configured with SPS Configuration Index 1, 2 and 3 respectively. SPS #1, SPS #2 and SPS #3 are activated with K₁=3, K₁=4 and K₁=1 respectively. These K₁ values result in the PUCCH for HARQ-ACK feedback corresponding to SPS #2 in Slot n, SPS #1 in Slot n+1 and SPS #3 in Slot n+3 being in the same slot, i.e. carried by PUCCH #2 in Slot n+4. PUCCH #2 therefore provides 3 HARQ-ACKs labelled as {ACK #1, ACK #2, ACK #3} for SPS #1, SPS #2 and SPS #3 respectively according to their SPS PDSCH Configuration Indices (it can be seen that, in this example, there is only one unique SPS PDSCH per DL slot that has HARQ-ACK multiplexed into PUCCH #2).

In Rel-16, when the PUCCH for an SPS PDSCH collides with the PUCCH for a DG-PDSCH, their HARQ-ACKs are multiplexed, where the SPS PDSCH HARQ-ACKs are appended after those for DG-PDSCH, if they have the same priority. Otherwise, one of the PUCCHs is prioritised.

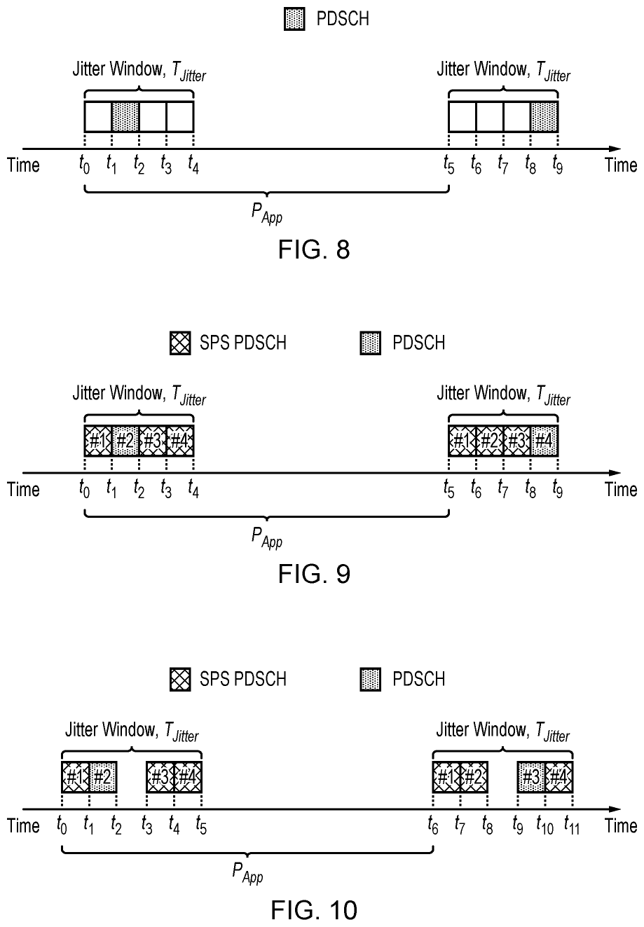

For some types of application traffic, while the scheduled packet arrival may be periodic, the actual arrival time of the packet may experience jitter causing it to arrive randomly within a jitter time window, T_{Jitter}. An example is shown in FIG. 8, where an application has periodic traffic with a periodicity of P_{App}. However, this traffic experiences jitter and so the actual packet arrival falls within a time window T_{Jitter}. In this example, the first jitter time window starts at time t₀ where the packet can arrive within this time window between t₀ to t₄ and here the packet arrives at time t₁. The next packet arrives after at least a time P_{App} later, starting at time t₅, and here once again the packet can arrive at any time within the jitter time window between t₅ to t₉. In the second instance, the packet arrives at time t₈, which is towards the end of the jitter time window T_{Jitter}.

SPS configuration provides PDSCH resources to the UE with a deterministic periodicity which can be from 1 to 640 slots. It is recognised that such deterministic periodicity configuration is not suitable for traffic experiencing jitter. In order to cater for jitter, multiple SPS configurations are used, where each SPS configuration has a different time offset, i.e. the SPS resource is over-configured. In the example in FIG. 8, the UE can be configured with four SPS PDSCH configurations, such that these four SPS fall within the jitter time window and each has a periodicity of P_{App}. An example is shown in FIG. 9, where four SPS configurations labelled as #1, #2, #3 and #4 with periodicity P_{App}, but different offsets, are configured for a UE. Hence, by configuring multiple SPS resources, the UE is therefore provided with PDSCH resource whenever the packet data arrives within the jitter time window.

It should be appreciated that the SPS resources configured within a jitter time window do not need to be adjacent to each other and there can be gaps between two SPS instances. An example is in FIG. 10, where four SPS instances, SPS #1, SPS #2, SPS #3 and SPS #4, are configured to handle jitter and here we have a gap between SPS #2 and SPS #3. It should also be appreciated that over-configuration of SPS resources is not limited to only traffic types with jitter but can also be used for traffic types that do not have a periodicity that matches those that are configurable by RRC.

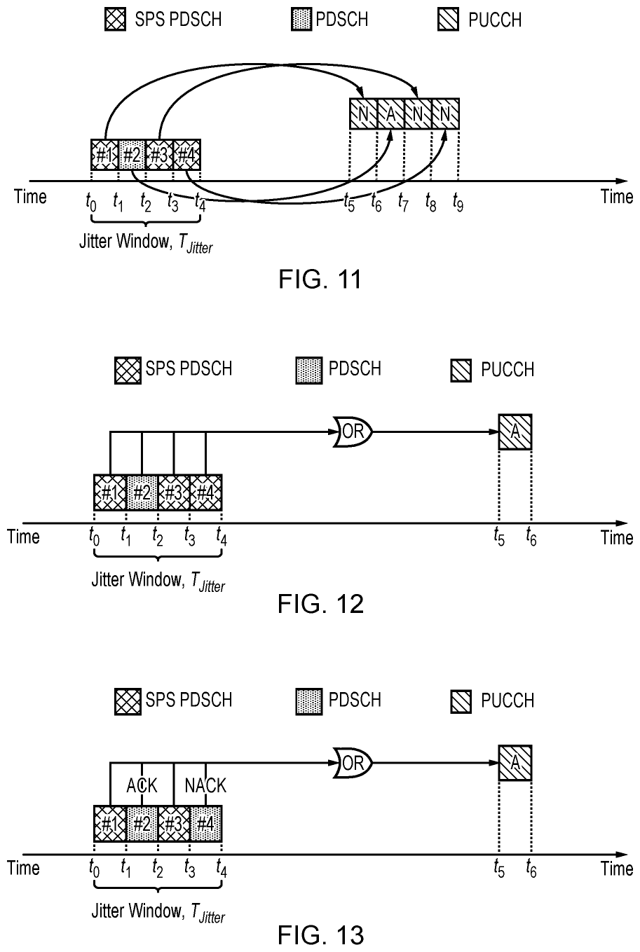

In Rel-16 SPS, the UE is required to feedback a NACK for an SPS that is unused, i.e. SPS resource that does not contain any PDSCH transmission. Therefore, using multiple-SPS configurations to handle jitter would lead to excessive HARQ-ACK overhead since only one of these SPS contains a valid PDSCH transmission. That is, within the jitter time window containing M SPS instances, only 1 out of M of these SPS instances has a valid PDSCH and therefore there would be an excess of M−1 HARQ-ACK feedbacks (where M−1 feedbacks would be NACK). An example is shown in FIG. 11, where M=4 SPS instances are configured within a jitter time window T_{Jitter}. Following Rel-16 behaviour, the UE would feedback all M HARQ-ACKs but only one HARQ-ACK, i.e. the one for SPS #2 transmitted between time t₆ to t₇, is beneficial to the gNB, thereby transmitting an excess of M−1=3 HARQ-ACK feedbacks.

Recognising this excessive HARQ-ACK overhead, it has been proposed in, for example, [5], [6], that the HARQ-ACK feedbacks for these M SPS instances within the jitter time window are bundled so that only a single HARQ-ACK feedback is sent, i.e. only one out of M HARQ-ACKs is fed back to the gNB. In [6], it is proposed to use an “OR” logical operator to perform the bundling, since M−1 HARQ-ACKs are expected to be NACK whilst only one of these M HARQ-ACKs can be ACK or NACK. An example is shown in FIG. 12, where once again M=4 SPS instances are configured to handle jitter but here only a single HARQ-ACK is fed back to the gNB by bundling all M HARQ-ACK feedbacks using a logical “OR” operator.

The proposal in [6] assumes that only one out of M SPS instances will be used. However, this is restrictive since the gNB cannot then use more than one out of the M SPS instances effectively, if there is other downlink traffic for the UE. If more than one SPS instance is being used, then the gNB would not be able to tell whether any of those used SPS instances contained a NACK due to the “OR” bundling and as a consequence of this, it may not perform retransmission of a NACKed SPS PDSCH, thereby reducing its reliability and increasing its latency. This is because the lower layers would not notice that there had been an error on the NACKed SPS PDSCH, while the time taken for higher layers to notice the NACK can be high, which will cause the increase in latency.

The overall reliability of the URLLC service can be reduced if some PDSCHs which are not received or are received erroneously are not indicated as being “NACK”. An example is shown in FIG. 13, where once again M=4 SPS instances are configured to handle jitter where the HARQ-ACK feedback for these SPSs are bundled using a logical “OR” operation. Here, the gNB decides to use SPS #4 to transmit a PDSCH to the UE but the UE fails to decode it. Since a logical “OR” is used to bundle all the HARQ-ACKs, the UE outputs a single ACK to the gNB, which may lead to the gNB not performing any retransmission for the PDSCH in SPS #4.

Therefore, a technical issue to solve is to reduce HARQ-ACK overhead for an over-configured SPS resource used to handle jitter, but in a manner which enables the gNB to identify a failed SPS PDSCH that is actually used when more than one of these SPS instances of the over-configured SPS resource are used. At a higher level, a technical issue also exists for reducing HARQ-ACK overhead for a bundle or set of PDSCHs, where such PDSCHs may be dynamically granted or SPS PDSCHs. For example, referring to FIG. 4, individual HARQ-ACKs for each of PDSCH #1, PDSCH #2, and PDSCH #3 are multiplexed into PUCCH #1 for transmission to the network. If the number of such PDSCHs increases, the overhead increases, as one HARQ-ACK is required to be transmitted for each of these PDSCHs. The same issue with the proposal in [6] applies to dynamically granted PDSCHs; transmitting an “OR” bundled HARQ-ACK for all PDSCHs may mean that one or more NACKed PDSCHs are missed and not retransmitted by the gNB. Embodiments of the present disclosure seek to provide solutions to such technical issues.

Number of ACKs in an SPS Group

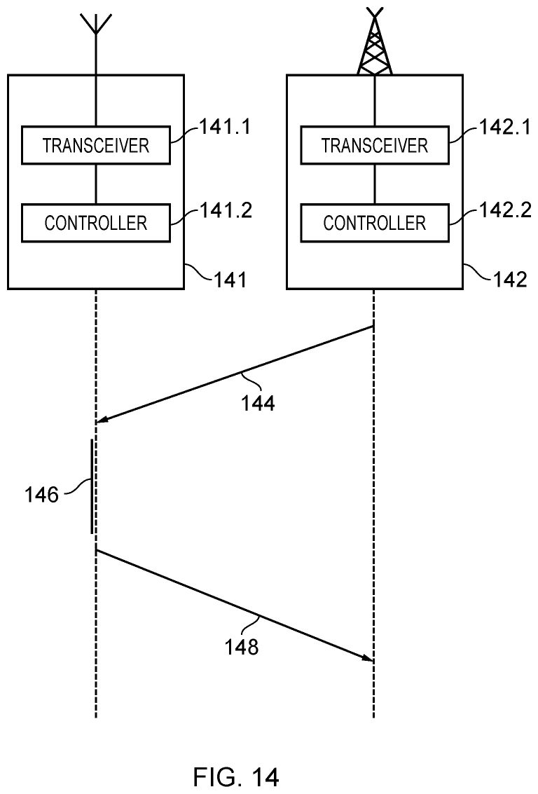

FIG. 14 shows a part schematic, part message flow diagram representation of a first wireless communications system comprising a communications device 141 and an infrastructure equipment 142 in accordance with at least some embodiments of the present technique. The communications device 141 is configured to transmit signals to and/or receive signals from the wireless communications network, for example, to and from the infrastructure equipment 142. Specifically, the communications device 141 may be configured to transmit data to and/or receive data from the wireless communications network (e.g. to/from the infrastructure equipment 142) via a wireless radio interface provided by the wireless communications network (e.g. the Uu interface between the communications device 141 and the Radio Access Network (RAN), which includes the infrastructure equipment 142). The communications device 141 and the infrastructure equipment 142 each comprise a transceiver (or transceiver circuitry) 141.1, 142.1, and a controller (or controller circuitry) 141.2, 142.2. Each of the controllers 141.2, 142.2 may be, for example, a microprocessor, a CPU, or a dedicated chipset, etc.

As shown in the example of FIG. 14, the transceiver circuitry 141.1 and the controller circuitry 141.2 of the communications device 141 are configured in combination to receive 144, from the wireless communications network (e.g. from the infrastructure equipment 142), signals on one or more downlink channels, each of the downlink channels being within one of a plurality of downlink transmission occasions, to determine 146, for each of the downlink channels, whether or not the signals have been successfully received by the communications device 141, and to transmit 148, to the wireless communications network (e.g. to the infrastructure equipment 142), an uplink control channel comprising an acknowledgement number indication, wherein the acknowledgement number indication indicates the number of the downlink transmission occasions within which the communications device 141 determines that the signals were successfully received on one of the downlink channels.

Essentially, embodiments of the present technique propose that a UE indicates a number of ACKs, M_{ACK}, for a number of downlink transmission occasions in a group of downlink transmission occasions. For example, these downlink transmission occasions may in some arrangements of embodiments of the present disclosure be SPS instances in an SPS group, but the downlink transmission occasions may alternatively be dynamically granted resources indicated to the UE in a DL grant carried by a DCI. In other words, the downlink transmission occasions are indicated by Downlink Control Information, DCI, received by the communications device from the wireless communications network (e.g. from the infrastructure equipment), or alternatively, the downlink transmission occasions are Semi-Persistent Scheduling, SPS, resource instances forming an SPS group, wherein the SPS resource instances are periodically located in a plurality of downlink resource units of the wireless radio interface. Here, the resource units may be, for example, slots, sub-slots, or subframes. Where reference is made to SPS resource instances or SPS groups in arrangements of embodiments of the present disclosure as described herein and as defined by the appended claims, those skilled in the art would appreciate that such arrangements may correspondingly apply to any kind of downlink transmission occasions or group of downlink transmission occasions in which PDSCHs may be received, such as those dynamically granted via DCIs.

Downlink channels (e.g. PDSCHs) may be received in all of the downlink transmission occasions (which, as described above, may be dynamically scheduled resources by DL grants or the like or may be non-dynamically scheduled resources such as SPS), or PDSCHs may only be received in some of the downlink transmission occasions; either because the gNB did not transmit them in those downlink transmission occasions, or the UE did not for some reason correctly detect or decode them. In any case, the indication of the number of ACKs, M_{ACK}, is for the plurality of downlink transmission occasions (e.g. SPS group) as a whole, and not just those within which PDSCHs are transmitted. The signals transmitted on the downlink channels (e.g. PDSCHs) may be the same in one or more of the downlink transmission occasions in which the PDSCHs are transmitted, or a different PDSCH carrying different data may be transmitted within downlink transmission occasions of the same group of downlink transmissions occasions.

Embodiments of the present disclosure recognise that the overhead, e.g. number of bits, required to indicate the number of ACKs in a group of downlink transmission occasions (e.g. in an SPS Group) is less than the number of bits required to indicate the HARQ-ACK status of each downlink transmission occasion (e.g. SPS instance) in the group.

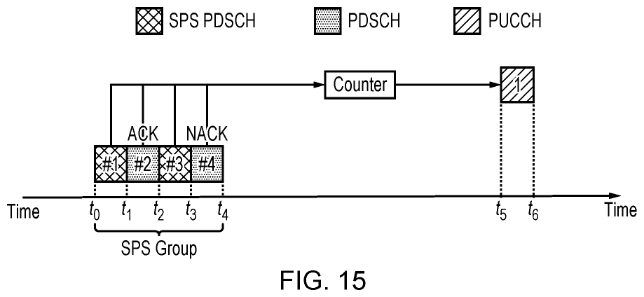

An example is shown in FIG. 15, where SPS #1, SPS #2, SPS #3 and SPS #4 belong to an SPS Group. Here, the gNB uses SPS #2 and SPS #4 to transmit a PDSCH to the UE but SPS #1 and SPS #3 are unused. The UE successfully decodes the PDSCH in SPS #2 but fails to decode the PDSCH in SPS #4. Hence, the UE feedbacks a count of 1 ACK (M_{ACK}=1) out of the 4 SPS instances. The gNB receiving a count of 1 ACK would therefore know that one of the two PDSCH instances that it had sent to the UE was not decoded correctly or not detected by the UE. The gNB can then retransmit one or both of the PDSCHs to the UE; it should be appreciated that where the number of PDSCHs is low (e.g. two in the example of FIG. 15), simply retransmitting all PDSCHs when the number of ACKs indicated by the UE is lower than the number of PDSCHs transmitted by the gNB is more efficient than trying to find out which PDSCH (or PDSCHs) was not ACKed and trying to retransmit that PDSCH (or PDSCHs) only. In contrast, for the method where a logical “OR” is used as proposed in [6], the gNB would not be able to determine whether there is a need to retransmit any PDSCH.

It should be appreciated that the UE may not try to first detect the presence of a PDSCH in an SPS instance, but instead may just try to decode a PDSCH in each SPS instance regardless of whether there was a PDSCH detected in the SPS instance or not. If there is no PDSCH in an SPS instance the UE would fail in its decoding process. Hence, in some UE implementations, the UE cannot distinguish between a NACK caused by the absence of PDSCH and a NACK caused by decoding failure. Solutions proposed by embodiments of the present disclosure, of counting and indicating the number of ACKs in an SPS Group (or more generally, a group of PDSCH transmission occasions), does not require the UE to detect the presence of PDSCHs, and so such solutions can be used regardless of whether the UE implements PDSCH detection or not.

Several arrangements of embodiments of the present technique are proposed below, regarding how the SPS Group (or indeed, more generally, a group of PDSCH transmission occasions) is determined. It should be appreciated that this SPS/PDSCH transmission occasion Group can be used for purposes other than the handling of jitter.

In an arrangement of embodiments of the present disclosure, the SPS Group is RRC configured. In other words, the communications device is configured to receive Radio Resource Control, RRC, signalling from the wireless communications network, and to determine, based on the RRC signalling, the plurality of SPS instances that form the SPS group (or, more generally, the plurality of downlink transmission occasions). In some implementations of this arrangement, each SPS instance can be RRC configured with a group ID, such that SPS instances that share the same group ID may be determined to belong to the same SPS Group. Here, the UE counts the number of ACKs (M_{ACK}); i.e. the number of active SPS instances that have a successfully decoded PDSCH, in this SPS Group. If the number of ACKs (M_{ACK}) matches the actual number of transmitted PDSCHs, then the gNB will assume that all PDSCHs were successfully decoded at the UE.

In another arrangement of embodiments of the present disclosure, the SPS Group is dynamically indicated. In other words, the communications device is configured to receive a dynamic indication from the wireless communications network, and to determine, based on the dynamic indication, the plurality of SPS instances that form the SPS group (or, more generally, the plurality of downlink transmission occasions).

In some implementations of this arrangement, the dynamic indicator may be the activation DCI that activates an SPS instance. In other words, the communications device is configured to receive, from the wireless communications network, an activation DCI indicating that one or more of the SPS resource instances are activated, wherein a field of the activation DCI comprises the dynamic indication.

In some such implementations, a new field is used to indicate the SPS Group in the activation DCI; e.g., this new field is introduced for the specific and dedicated purpose of carrying the dynamic indication. This new field can indicate the SPS Group ID for each activated SPS instance.

In some other such implementations, an existing field in the activation DCI is used to indicate the SPS Group. This said existing field can be re-interpreted to explicitly carry the dynamic indication of the SPS group in addition to its existing purpose, or may alternatively in some manner implicitly indicate the SPS Group. For example, in an arrangement of embodiments of the present disclosure, the existing DCI field may be the “PDSCH-to-HARQ_feedback timing indicator” field where the K₁ value is used to implicitly indicate the SPS Group. Here, the SPS instances with K₁ values that point to the same PUCCH in a slot or sub-slot for their corresponding HARQ-ACKs would belong to the same SPS Group. In other words, the existing field indicates, for each of the SPS resource instances, a resource unit of the wireless radio interface in which the uplink control channel should be transmitted, and wherein the communications device is configured to determine that the SPS group is formed by the plurality of SPS instances when the existing field indicates that the uplink control channel should be transmitted in the same resource unit for all of the plurality of SPS instances.

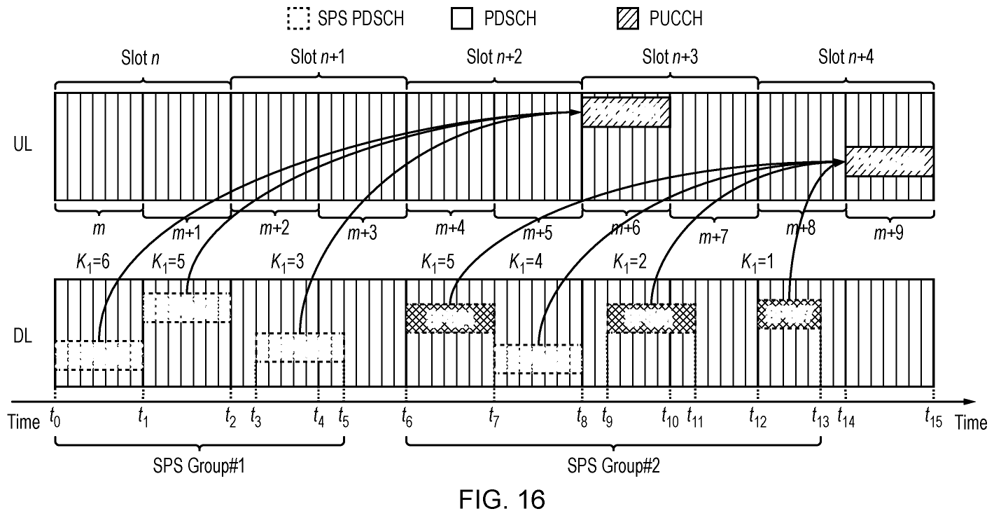

An example is shown in FIG. 16, where a seven-OFDM symbol sub-slot based PUCCH is used and the gNB configures seven SPS configurations labelled as SPS #1, SPS #2, SPS #3, SPS #4, SPS #5, SPS #6 and SPS #7. These seven SPS configurations are activated individually, where their activation DCIs indicate K₁ values of {6, 5, 3, 5, 4, 2, 1} for SPS #1, SPS #2, SPS #3, SPS #4, SPS #5, SPS #6 and SPS #7 respectively. The K₁ values lead to the HARQ-ACK feedbacks for SPS #1, SPS #2 and SPS #3 being carried by PUCCH #1 in sub-slot m+6 and the HARQ-ACK feedbacks for SPS #4, SPS #5, SPS #6 and SPS #7 being carried by PUCCH #2 in sub-slot m+9. As per this arrangement, since SPS #1, SPS #2 and SPS #3 share a PUCCH, i.e. PUCCH #1, these SPS instances are determined by the UE to belong to an SPS Group, labelled as SPS Group #1. Similarly, SPS #4, SPS #5, SPS #6 and SPS #7 belong to another SPS Group, i.e. SPS Group #2, since their HARQ-ACKs are carried by the same PUCCH, i.e. PUCCH #2.

In another arrangement of embodiments of the present disclosure, the MAC-CE in a PDSCH of a used SPS instance will indicate which other SPS instances belong to the same SPS Group. In other words, the communications device is configured to determine, based on a Medium Access Control, MAC, Control Element, CE, within one of the received downlink channels, the plurality of SPS instances that form the SPS group (or, more generally, the plurality of downlink transmission occasions).

Several arrangements of embodiments of the present technique are proposed below, regarding how the number of ACKs, M_{ACK}, in an SPS Group (or indeed, more generally, a group of PDSCH transmission occasions) may be indicated.

In an arrangement of embodiments of the present disclosure, PUCCH Format 0 is used to indicate M_{ACK} for the SPS group. PUCCH Format 0 is sequence based where eight cyclic shifts of the sequence are used to indicate 13 different states to represent combinations of positive/negative SR and either one or two HARQ-ACK statuses as shown in Table I. It is recognised that these eight cyclic shifts are sufficient to indicate the number of ACKs for an SPS Group with seven SPS instances. In other words, the acknowledgement number indication is indicated by a cyclic shift amount used for the transmission of the uplink control channel. It should be noted that, in Rel-16, a UE can be configured with at most eight SPS instances.

TABLE I
Cyclic shifts for different combinations
of HARQ-ACK + SR in legacy system

| HARQ-ACK | | | |
|---|---|---|---|
| | HARQ-ACK UCI | | Cyclic |
| State | bits | SR | Shift m_{CS} |
| None | 0 | Positive | m_{CS} = 0 |
| {NACK} | 1 | Negative | m_{CS} = 0 |
| {ACK} | 1 | Negative | m_{CS} = 6 |
| {NACK} | 1 | Positive | m_{CS} = 3 |
| {ACK} | 1 | Positive | m_{CS} = 9 |
| {NACK, NACK} | 2 | Negative | m_{CS} = 0 |
| {NACK, ACK} | 2 | Negative | m_{CS} = 3 |
| {ACK, ACK} | 2 | Negative | m_{CS} = 6 |
| {ACK, NACK} | 2 | Negative | m_{CS} = 9 |
| {NACK, NACK} | 2 | Positive | m_{CS} = 1 |
| {NACK, ACK} | 2 | Positive | m_{CS} = 4 |
| {ACK, ACK} | 2 | Positive | m_{CS} = 7 |
| {ACK, NACK} | 2 | Positive | m_{CS} = 10 |

An example, according to this arrangement, where the eight existing cyclic shifts are used to indicate M_{ACK} for an SPS Group with seven SPS instances is shown in Table II below. It should be appreciated Table II illustrates just one example, and different cyclic shifts to those indicated in this table can be used to indicate different M_{ACK} values; for example, instead of using cyclic shift m_{cs}=6 to indicate four ACKs, it can be used instead to indicate seven ACKs, and other cyclic shifts can be used to indicate other numbers of ACKs. Furthermore, the number of cyclic shifts and amounts of cyclic shift for each of these cyclic shifts may be different to those shown in Table II below. For example, if eight SPS instances are required in an SPS Group, then a new cyclic shift can be introduced to PUCCH Format 0, i.e. nine cyclic shifts, to indicate up to eight ACKs.

TABLE II
Re-interpretation of PUCCH Format 0 to indicate M_{ACK}

| Cyclic Shift m_{CS} | M_{ACK} |
|---|---|
| m_{CS} = 0 | 0 |
| m_{CS} = 1 | 1 |
| m_{CS} = 3 | 2 |
| m_{CS} = 4 | 3 |
| m_{CS} = 6 | 4 |
| m_{CS} = 7 | 5 |
| m_{CS} = 9 | 6 |
| m_{CS} = 10 | 7 |

In another arrangement of embodiments of the present technique, one cyclic shift can be used to represent two or more values of M_{ACK}. For example, cyclic shift m_{CS}=0 can be used to indicate zero ACKs or eight ACKs. In other words, one or more of the cyclic shift amounts indicate more than one number of the downlink transmission occasions within which the communications device determines that the signals were successfully received on one of the downlink channels. This arrangement recognises that if the gNB sends eight PDSCHs, it is unlikely that the UE fails to decode none of them. It should be appreciated that other mappings of cyclic shift to two or more numbers of ACKs are possible.

In another arrangement of embodiments of the present disclosure, the set of M_{ACK} are divided into two or more subsets and different scrambling sequences of the PUCCH are used to indicate different subsets of M_{ACK}. In other words, the acknowledgement number indication indicates one of a plurality of sets of acknowledgement numbers. Here, the acknowledgement number indication may additionally indicate in one or more bits, from within the indicated set of acknowledgement numbers, the number of the downlink transmission occasions within which the communications device determines that the signals were successfully received on one of the downlink channels. For example, for an SPS Group with seven SPS instances, the set of M_{ACK} can be divided into two subsets, M_{ACK-1}={0, 1, 2, 3} and M_{ACK-2}={4, 5, 6, 7}. A PUCCH with two bits can then be used to indicate the set of M_{ACK} where the PUCCH uses two different scrambling codes, i.e. one scrambling to indicate subset M_{ACK-1} and another scrambling code to indicate subset M_{ACK-2}. In other words, the indicated set of acknowledgement numbers is indicated by a scrambling code used for the transmission of the uplink control channel. It should be appreciated that although this example used only two M_{ACK} subsets, this arrangement is applicable for more than two M_{ACK} subsets and each subset can have different orders of M_{ACK} values, for example M_{ACK-1}={1, 5, 2, 7} and M_{ACK-2}={0, 3, 4, 6}.

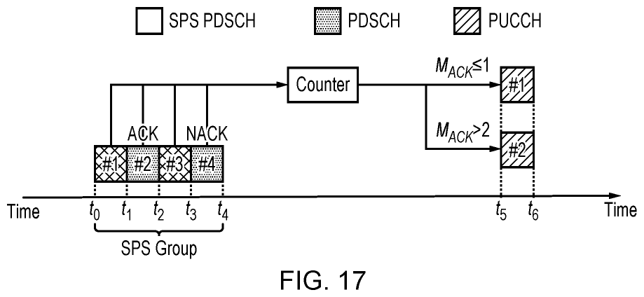

In another arrangement of embodiments of the present disclosure, the set of M_{ACK} are divided into two or more subsets and different PUCCH resources are used to indicate the different subsets of M_{ACK}. In other words, the indicated set of acknowledgement numbers is indicated by a set of resources of the wireless radio interface used for the transmission of the uplink control channel. The PUCCH can be in the same slot or different slots. An example is shown in FIG. 17, where an SPS Group of 4 SPS instances, SPS #1, SPS #2, SPS #3 & SPS #4, is configured for a UE. The set of M_{ACK} values are divided into two subsets M_{ACK-1}={0, 1} and M_{ACK-2}={2, 3, 4} and their M_{ACK} values are carried by PUCCH #1 and PUCCH #2 respectively. In this example different numbers of bits can be used for PUCCH #1 and PUCCH #2, i.e. PUCCH #1 needs only one bit to indicate {0, 1} and PUCCH #2 requires two bits to indicate {2, 3, 4}. Here the gNB transmits PDSCH to the UE in SPS #2 and SPS #4. The UE does not perform PDSCH detection but tries to decode every SPS and could only successfully decode the PDSCH in SPS #2. It therefore uses PUCCH #1 to indicate M_{ACK}=1. Since the gNB sent two PDSCHs but received only a count of one ACK, it knows the UE failed to decode one of them and can therefore retransmit one or both of the PDSCHs.

In another arrangement of embodiments of the present disclosure, two or more values of M_{ACK} can be represented by one single state of an indicator In other words, the acknowledgement number indication indicates in one or more bits, the number of the downlink transmission occasions within which the communications device determines that the signals were successfully received on one of the downlink channels, wherein one or more configurations of the one or more bits indicates more than one number of the downlink transmission occasions within which the communications device determines that the signals were successfully received on one of the downlink channels. This is beneficial if the number of bits in the indicator is limited or is not sufficient to indicate all the possible values of M_{ACK}. For example, an SPS Group with four SPS instances can use a two-bit indicator, i.e. with four states, and the states can be:
“00” means M_{ACK}=0 (no ACKs)
“01” means M_{ACK}=1 (1 ACKs)
“10” means M_{ACK}=2 (2 ACKs)
“11” means M_{ACK}≥3 (3 or 4 ACKs)

In this example, it is assumed that the gNB would rarely use all four SPS instances to carry PDSCHs, and so for most cases where the index or configuration “11” is used, it is used when the gNB has transmitted three rather than four PDSCHs to the UE. It should be appreciated that other representations can be used, e.g. “00” means M_{ACK}={0, 1} “01” means M_{ACK}={2}, “10” means M_{ACK}={3} and “11” means M_{ACK}={4}. The assignment of M_{ACK} values to each state of the indicator can be configurable or fixed in the specifications.

Several arrangements of embodiments of the present technique are proposed below, regarding how whether or not the communications device should indicate M_{ACK} or the HARQ-ACK status of each SPS instance in an SPS Group can be enabled or disabled by the network. Here, in other words, the communications device is configured to determine whether transmitting the acknowledgement number indication is enabled or disabled, and to transmit, to the wireless communications network, the uplink control channel comprising the acknowledgement number indication only when the communications device determines that transmitting the acknowledgement number indication is enabled. The communications device may then be configured to transmit, to the wireless communications network for each of the downlink transmission occasions when the communications device determines that transmitting the acknowledgement number indication is disabled, an indication of whether signals were successfully received on one of the downlink channels.

In an arrangement of embodiments of the present disclosure, the UE is RRC configured whether to indicate M_{ACK} or the HARQ-ACK status of each SPS instance in a configured SPS Group. In other words, the communications device is configured to receive RRC signalling from the wireless communications network, wherein the determining whether transmitting the acknowledgement number indication is enabled or disabled is based on the RRC signalling.

In another arrangement of embodiments of the present disclosure, the activation or deactivation DCI can indicate whether the UE indicates M_{ACK} or HARQ-ACK status for the SPS instances in an SPS Group. In other words, the downlink transmission occasions are SPS resource instances forming an SPS group, wherein the SPS resource instances are periodically located in a plurality of downlink resource units of the wireless radio interface, and wherein the communications device is configured to receive, from the wireless communications network, an activation DCI indicating that one or more of the SPS resource instances are activated, wherein the determining whether transmitting the acknowledgement number indication is enabled or disabled is based on the activation DCI.

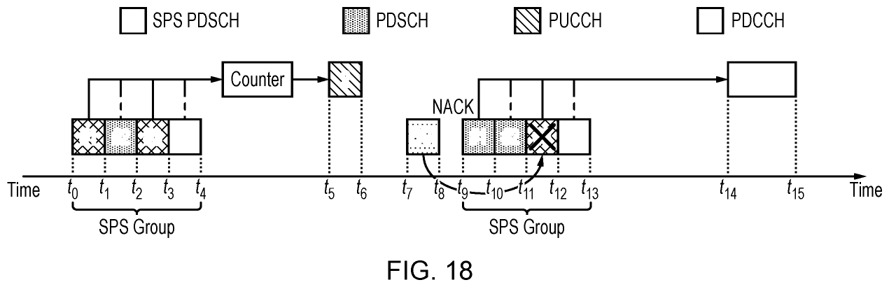

An example is shown in FIG. 18, where an SPS Group with four SPS instances, SPS #1, SPS #2, SPS #3 and SPS #4, are initially configured or indicated to feed back M_{ACK}. Here, at time t₀ to t₄, the gNB transmits two PDSCHs to the UE, where the UE successfully decodes both of them and feeds back M_{ACK}=2 on a PUCCH at time t₅. At time t₇, the gNB sends a deactivation DCI to deactivate SPS #3 and here, it also tells the UE to indicate the HARQ-ACK status for each SPS instance in the SPS Group. At time t₉, the gNB sends three PDSCHs to the UE using SPS #1, SPS #2 and SPS #4. The UE fails to decode PDSCH in SPS #1 but successfully decodes PDSCHs in SPS #2 and SPS #4 and therefore it feeds back {NACK, ACK, ACK}, i.e. the HARQ-ACK status of each activated SPS instance, to the gNB in a PUCCH at time t₁₄.

In another arrangement of embodiments of the present disclosure, the UE determines whether to feedback M_{ACK} or HARQ-ACK status for the SPS instances in an SPS Group depending upon whether the number of SPS instances N_{SPS} in the SPS Group is greater than a threshold T_{SPS}. In other words, the communications device is configured to determine the number of the downlink transmission occasions, wherein the determining whether transmitting the acknowledgement number indication is enabled or disabled is based on whether or not the number of the downlink transmission occasions exceeds a threshold number. For example, if N_{SPS}>T_{SPS}, then the UE feeds back M_{ACK}, otherwise it feeds back HARQ-ACK status. This arrangement recognises that more feedback overhead is saved when N_{SPS} is large. For example, T_{SPS}=2, and if N_{SPS}=2, then providing HARQ-ACK status for each SPS instance individually or M_{ACK} would both require two bits and so it is more beneficial and no less efficient for the UE to provide a HARQ-ACK status for each SPS instance individually. The threshold T_{SPS} can be RRC configured, indicated in the DCI or fixed in the specifications.

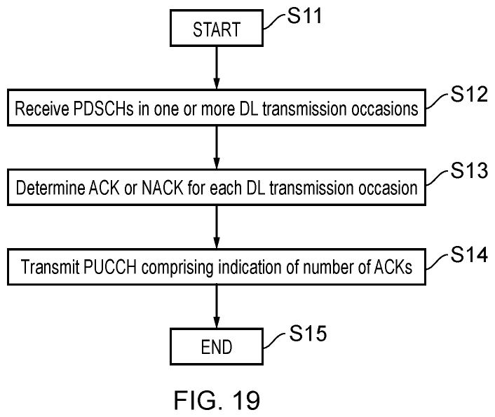

FIG. 19 shows a flow diagram illustrating a first example process of communications in a communications system in accordance with embodiments of the present technique. The process shown by FIG. 19 is a method of operating a communications device configured to transmit signals to and/or to receive signals from a wireless communications network (e.g. to or from an infrastructure equipment of the wireless communications network).

The method begins in step S11. The method comprises, in step S12, receiving, from the wireless communications network, signals on one or more downlink channels, each of the downlink channels being within one of a plurality of downlink transmission occasions. In step S13, the process comprises determining, for each of the downlink channels, whether or not the signals have been successfully received by the communications device. In step S14, the method comprises transmitting, to the wireless communications network, an uplink control channel comprising an acknowledgement number indication, wherein the acknowledgement number indication indicates the number of the downlink transmission occasions within which the communications device determines that the signals were successfully received on one of the downlink channels. The process ends in step S15.

In some embodiments of the present technique when the number of PDSCHs N_{PDSCH}, scheduled in the SPS instances in an SPS Group (or, more generally, a group of PDSCH transmission occasions) exceeds a threshold T_{PDSCH}, the gNB automatically schedules a retransmission of one or more of these PDSCHs.

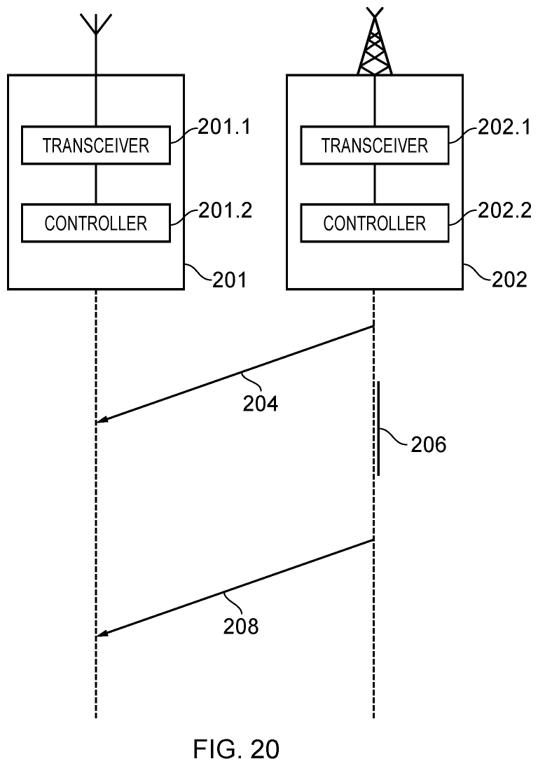

Such embodiments of the present disclosure may be exemplified by FIG. 20, which shows a part schematic, part message flow diagram representation of a first wireless communications system comprising a communications device 201 and an infrastructure equipment 202 in accordance with at least some embodiments of the present technique. The infrastructure equipment 202 is configured to transmit signals to and/or receive signals from the communications device 201. Specifically, the infrastructure equipment 202 may be configured to transmit data to and/or receive data from the communications device 201 via a wireless radio interface provided by the wireless communications network (e.g. the Uu interface between the communications device 201 and the RAN, which includes the infrastructure equipment 202).

The communications device 201 and the infrastructure equipment 202 each comprise a transceiver (or transceiver circuitry) 201.1, 202.1, and a controller (or controller circuitry) 201.2, 202.2. Each of the controllers 201.2, 202.2 may be, for example, a microprocessor, a CPU, or a dedicated chipset, etc.

As shown in the example of FIG. 20, the transceiver circuitry 201.1 and the controller circuitry 201.2 of the infrastructure equipment 202 are configured in combination to transmit 204, to the communications device 201, signals on one or more downlink channels, each of the downlink channels being within one of a plurality of downlink transmission occasions, to determine 206 whether the number of downlink channels on which the signals are transmitted exceeds a threshold number, and, if the number of downlink channels on which the signals are transmitted exceeds the threshold number to retransmit 208, to the communications device 201, the signals on at least one of the downlink channels.

Here, the infrastructure equipment 202 may be configured to determine that the infrastructure equipment 202 is to receive, from the communications device 201, an uplink control channel comprising an acknowledgement number indication, wherein the acknowledgement number indication indicates the number of the downlink transmission occasions within which the communications device 201 has successfully received the signals on one of the downlink channels, wherein the threshold number is equal to a maximum number of downlink transmission occasions that can be indicated by the acknowledgement number indication.

For example, T_{PDSCH}=3, in an SPS Group with four SPS instances and the PUCCH can carry only two bits, i.e. can indicate a maximum M_{ACK}=3. Hence, if the gNB schedules N_{PDSCH}=4, i.e. N_{PDSCH}>T_{PDSCH}, then the gNB would not be able to determine whether the UE has received three PDSCHs or four PDSCHs successfully. Therefore, in accordance with such embodiments of the present technique, the gNB automatically schedules a retransmission or provides a repetition of one or more of the PDSCHs.

In another example, if the SPS Group uses a logical “OR” as described in [6], then T_{PDSCH}=1, and if the gNB schedules more than one PDSCH, i.e. N_{PDSCH}>T_{PDSCH}, then the gNB can provide repetition or an automatic retransmission, because for the same reason it knows that it will not be able to determine, if it receives an ACK, whether the UE has received all of the PDSCHs correctly, or fewer than all of the PDSCHs (but at least one PDSCH) successfully.

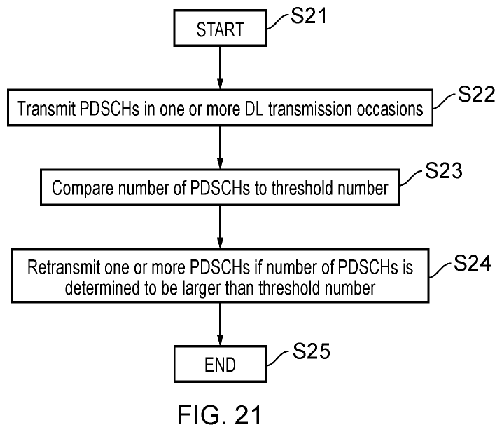

FIG. 21 shows a flow diagram illustrating a second example process of communications in a communications system in accordance with embodiments of the present technique. The process shown by FIG. 21 is a method of operating an infrastructure equipment forming part of a wireless communications network configured to transmit signals to and/or to receive signals from a communications device.

The method begins in step S21. The method comprises, in step S22, transmitting, to the communications device, signals on one or more downlink channels, each of the downlink channels being within one of a plurality of downlink transmission occasions. In step S23, the process comprises determining whether the number of downlink channels on which the signals are transmitted exceeds a threshold number. If the number of downlink channels on which the signals are transmitted exceeds the threshold number, the method then comprises, in step S24, retransmitting, to the communications device, the signals on at least one of the downlink channels. The process ends in step S25.

In some embodiments of the present technique, the gNB can indicate to the UE the number of PDSCHs, N_{PDSCH}, that the gNB transmits to the UE. That is, the gNB tells the UE the expected number of ACKs the UE should see in the SPS Group.

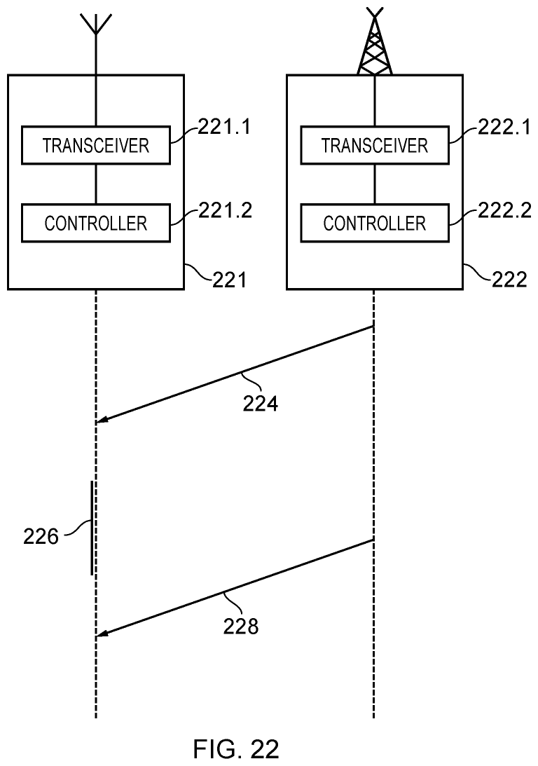

Such embodiments of the present disclosure may be exemplified by FIG. 22, which shows a part schematic, part message flow diagram representation of a first wireless communications system comprising a communications device 221 and an infrastructure equipment 222 in accordance with at least some embodiments of the present technique. The communications device 221 is configured to transmit signals to and/or receive signals from the wireless communications network, for example, to and from the infrastructure equipment 222. Specifically, the communications device 221 may be configured to transmit data to and/or receive data from the wireless communications network (e.g. to/from the infrastructure equipment 222) via a wireless radio interface provided by the wireless communications network (e.g. the Uu interface between the communications device 221 and the RAN, which includes the infrastructure equipment 222). The communications device 221 and the infrastructure equipment 222 each comprise a transceiver (or transceiver circuitry) 221.1, 222.1, and a controller (or controller circuitry) 221.2, 222.2. Each of the controllers 221.2, 222.2 may be, for example, a microprocessor, a CPU, or a dedicated chipset, etc.

As shown in the example of FIG. 22, the transceiver circuitry 221.1 and the controller circuitry 221.2 of the communications device 221 are configured in combination to receive 224, from the wireless communications network (e.g. from the infrastructure equipment 222), signals on one or more downlink channels, each of the downlink channels being within one of a plurality of downlink transmission occasions, to determine 226, for each of the downlink channels, whether or not the signals have been successfully received by the communications device 221, and to receive 228, from the wireless communications network (e.g. from the infrastructure equipment 222), an indication of the number of the one or more downlink channels on which the signals either have been or will be received.

In some such arrangements, the UE may then count the number of ACKs, M_{ACK} and if M_{ACK}=N_{PDSCH}, the UE sends an ACK otherwise it sends a NACK. In other words, if the number of the downlink transmission occasions within which the communications device determines that the signals were successfully received on one of the downlink channels is the same as the indicated number of the one or more downlink channels on which the signals either have been or will be received, the communications device is configured to transmit, to the wireless communications network, an uplink control channel comprising a positive acknowledgement. Alternatively, if the number of the downlink transmission occasions within which the communications device determines that the signals were successfully received on one of the downlink channels is not the same as the indicated number of the one or more downlink channels on which the signals either have been or will be received, the communications device is configured to transmit, to the wireless communications network, an uplink control channel comprising a negative acknowledgement.

It will be understood that instead of explicitly sending an uplink control channel to indicate a positive acknowledgement or a negative acknowledgement, the acknowledgement status may alternatively be indicated by the communications device not sending an uplink control channel. For example, if the number of the downlink transmission occasions within which the communications device determines that the signals were successfully received on one of the downlink channels is the same as the indicated number of the one or more downlink channels on which the signals either have been or will be received, the communications device is configured to transmit, to the wireless communications network, an uplink control channel comprising a positive acknowledgement. Alternatively, if the number of the downlink transmission occasions within which the communications device determines that the signals were successfully received on one of the downlink channels is not the same as the indicated number of the one or more downlink channels on which the signals either have been or will be received, the communications device is configured to determine that it should not transmit an uplink control channel Based on not receiving an uplink control channel, the infrastructure equipment may determine that one or more of the downlink channels were not successfully received by the communications device.

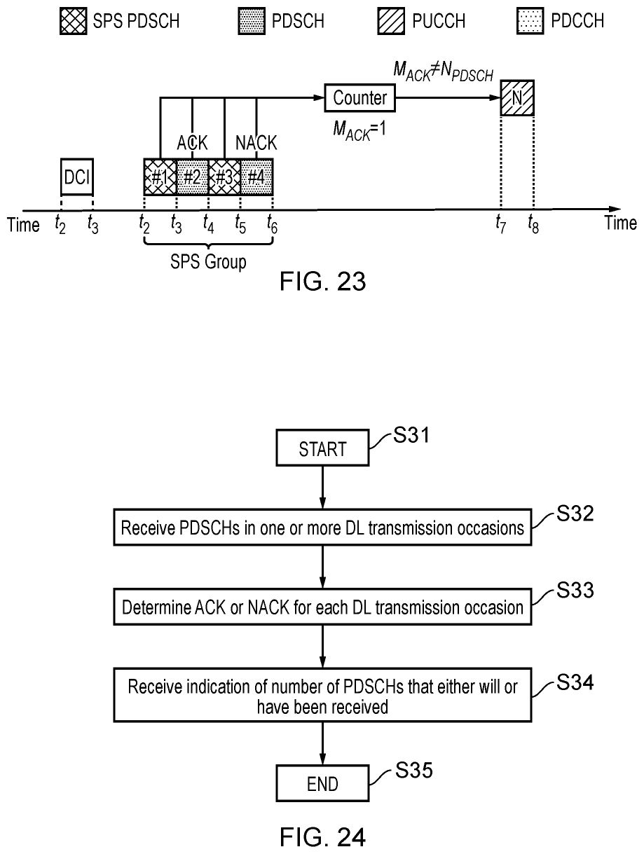

An example of such embodiments is shown in FIG. 23, where an SPS Group has four SPS instances. At time t₀, the gNB indicates to the UE that N_{PDSCH}=2. The UE then decodes the SPS in the SPS Group and counts only one ACK, i.e. M_{ACK}=1. Since M_{ACK}□N_{PDSCH}, the UE feeds back a NACK to the gNB.

FIG. 24 shows a flow diagram illustrating a third example process of communications in a communications system in accordance with embodiments of the present technique. The process shown by FIG. 24 is a method of operating a communications device configured to transmit signals to and/or to receive signals from a wireless communications network (e.g. to or from an infrastructure equipment of the wireless communications network).

The method begins in step S31. The method comprises, in step S32, receiving, from the wireless communications network, signals on one or more downlink channels, each of the downlink channels being within one of a plurality of downlink transmission occasions. In step S33, the process comprises determining, for each of the downlink channels, whether or not the signals have been successfully received by the communications device. The method then comprises, in step S34, receiving, from the wireless communications network, an indication of the number of the one or more downlink channels on which the signals either have been or will be received. The process ends in step S35.

Those skilled in the art would appreciate that the methods shown by FIGS. 19, 21, and 24 may be adapted in accordance with embodiments of the present technique. For example, other intermediate steps may be included in either or both of these methods, or the steps may be performed in any logical order.

Though embodiments of the present technique have been described largely by way of the example communications systems shown in FIGS. 14, 20, and 22, and described by way of the arrangements shown by FIGS. 15 to 18 and 23, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:
Paragraph 1. A method of operating a communications device configured to transmit signals to and/or to receive signals from a wireless communications network via a wireless radio interface provided by the wireless communications network, the method comprising
   receiving, from the wireless communications network, signals on one or more downlink channels, each of the downlink channels being within one of a plurality of downlink transmission occasions,
   determining, for each of the downlink channels, whether or not the signals have been successfully received by the communications device, and
   transmitting, to the wireless communications network, an uplink control channel comprising an acknowledgement number indication, wherein the acknowledgement number indication indicates the number of the downlink transmission occasions within which the communications device determines that the signals were successfully received on one of the downlink channels.
Paragraph 2. A method according to Paragraph 1, wherein the downlink transmission occasions are indicated by Downlink Control Information, DCI, received by the communications device from the wireless communications network.
Paragraph 3. A method according to Paragraph 1 or Paragraph 2, wherein the downlink transmission occasions are Semi-Persistent Scheduling, SPS, resource instances forming an SPS group, wherein the SPS resource instances are periodically located in a plurality of downlink resource units of the wireless radio interface.
Paragraph 4. A method according to Paragraph 3, comprising
   receiving Radio Resource Control, RRC, signalling from the wireless communications network, and
   determining, based on the RRC signalling, the plurality of SPS instances that form the SPS group.
Paragraph 5. A method according to Paragraph 3 or Paragraph 4, comprising
   receiving a dynamic indication from the wireless communications network, and determining, based on the dynamic indication, the plurality of SPS instances that form the SPS group.
Paragraph 6. A method according to Paragraph 5, comprising
   receiving, from the wireless communications network, an activation DCI indicating that one or more of the SPS resource instances are activated,
   wherein a field of the activation DCI comprises the dynamic indication.
Paragraph 7. A method according to Paragraph 6, wherein the field of the activation DCI is a new field which is dedicated to the purpose of carrying the dynamic indication.
Paragraph 8. A method according to Paragraph 7, wherein the new field indicates an identifier of the SPS group for each of the SPS resource instances.
Paragraph 9. A method according to any of Paragraphs 6 to 8, wherein the field of the activation DCI is an existing field which is additionally used to carry the dynamic indication.
Paragraph 10. A method according to Paragraph 9, wherein the existing field indicates, for each of the SPS resource instances, a resource unit of the wireless radio interface in which the uplink control channel should be transmitted, and wherein the method comprises
   determining that the SPS group is formed by the plurality of SPS instances when the existing field indicates that the uplink control channel should be transmitted in the same resource unit for all of the plurality of SPS instances.
Paragraph 11. A method according to any of Paragraphs 3 to 10, comprising
   determining, based on a Medium Access Control, MAC, Control Element, CE, within one of the received downlink channels, the plurality of SPS instances that form the SPS group.
Paragraph 12. A method according to any of Paragraphs 1 to 11, comprising
   receiving RRC signalling from the wireless communications network, and
   determining, based on the RRC signalling, the plurality of downlink transmission occasions.
Paragraph 13. A method according to any of Paragraphs 1 to 12, comprising receiving a dynamic indication from the wireless communications network, and determining, based on the dynamic indication, the plurality of downlink transmission occasions.
Paragraph 14. A method according to any of Paragraphs 1 to 13, comprising
   determining, based on a Medium Access Control, MAC, Control Element, CE, within one of the received downlink channels, the plurality of downlink transmission occasions.
Paragraph 15. A method according to any of Paragraphs 1 to 14, wherein the acknowledgement number indication is indicated by a cyclic shift amount used for the transmission of the uplink control channel
Paragraph 16. A method according to Paragraph 15, wherein one or more of the cyclic shift amounts indicate more than one number of the downlink transmission occasions within which the communications device determines that the signals were successfully received on one of the downlink channels.
Paragraph 17. A method according to any of Paragraphs 1 to 16, wherein the acknowledgement number indication indicates one of a plurality of sets of acknowledgement numbers.
Paragraph 18. A method according to Paragraph 17, wherein the indicated set of acknowledgement numbers is indicated by a scrambling code used for the transmission of the uplink control channel
Paragraph 19. A method according to Paragraph 17 or Paragraph 18, wherein the indicated set of acknowledgement numbers is indicated by a set of resources of the wireless radio interface used for the transmission of the uplink control channel
Paragraph 20. A method according to any of Paragraphs 17 to 19, wherein the acknowledgement number indication indicates in one or more bits, from within the indicated set of acknowledgement numbers, the number of the downlink transmission occasions within which the communications device determines that the signals were successfully received on one of the downlink channels.
Paragraph 21. A method according to any of Paragraphs 1 to 20, wherein the acknowledgement number indication indicates in one or more bits, the number of the downlink transmission occasions within which the communications device determines that the signals were successfully received on one of the downlink channels.
Paragraph 22. A method according to Paragraph 21, wherein one or more configurations of the one or more bits indicates more than one number of the downlink transmission occasions within which the communications device determines that the signals were successfully received on one of the downlink channels.
Paragraph 23. A method according to any of Paragraphs 1 to 22, comprising
   determining whether transmitting the acknowledgement number indication is enabled or disabled, and
   transmitting, to the wireless communications network, the uplink control channel comprising the acknowledgement number indication only when the communications device determines that transmitting the acknowledgement number indication is enabled.
Paragraph 24. A method according to Paragraph 23, comprising
   transmitting, to the wireless communications network for each of the downlink transmission occasions when the communications device determines that transmitting the acknowledgement number indication is disabled, an indication of whether signals were successfully received on one of the downlink channels.
Paragraph 25. A method according to Paragraph 23 or Paragraph 24, comprising
   receiving RRC signalling from the wireless communications network,
   wherein the determining whether transmitting the acknowledgement number indication is enabled or disabled is based on the RRC signalling.
Paragraph 26. A method according to any of Paragraphs 23 to 25, wherein the downlink transmission occasions are SPS resource instances forming an SPS group, wherein the SPS resource instances are periodically located in a plurality of downlink resource units of the wireless radio interface, and wherein the method comprises
   receiving, from the wireless communications network, an activation DCI indicating that one or more of the SPS resource instances are activated,
   wherein the determining whether transmitting the acknowledgement number indication is enabled or disabled is based on the activation DCI.
Paragraph 27. A method according to any of Paragraphs 23 to 26, comprising
   determining the number of the downlink transmission occasions,
   wherein the determining whether transmitting the acknowledgement number indication is enabled or disabled is based on whether or not the number of the downlink transmission occasions exceeds a threshold number.
Paragraph 28. A communications device configured to transmit signals to and/or to receive signals from a wireless communications network, the communications device comprising
   transceiver circuitry configured to transmit signals and receive signals via a wireless radio interface provided by the wireless communications network, and
   controller circuitry configured in combination with the transceiver circuitry
   to receive, from the wireless communications network, signals on one or more downlink channels, each of the downlink channels being within one of a plurality of downlink transmission occasions,
   to determine, for each of the downlink channels, whether or not the signals have been successfully received by the communications device, and
   to transmit, to the wireless communications network, an uplink control channel comprising an acknowledgement number indication, wherein the acknowledgement number indication indicates the number of the downlink transmission occasions within which the communications device determines that the signals were successfully received on one of the downlink channels.
Paragraph 29. Circuitry for a communications device configured to transmit signals to and/or to receive signals from a wireless communications network, the circuitry comprising
   transceiver circuitry configured to transmit signals and receive signals via a wireless radio interface provided by the wireless communications network, and
   controller circuitry configured in combination with the transceiver circuitry
   to receive, from the wireless communications network, signals on one or more downlink channels, each of the downlink channels being within one of a plurality of downlink transmission occasions,
   to determine, for each of the downlink channels, whether or not the signals have been successfully received by the communications device, and
   to transmit, to the wireless communications network, an uplink control channel comprising an acknowledgement number indication, wherein the acknowledgement number indication indicates the number of the downlink transmission occasions within which the communications device determines that the signals were successfully received on one of the downlink channels.
Paragraph 30. A method of operating an infrastructure equipment forming part of a wireless communications network configured to transmit signals to and/or to receive signals from a communications device via a wireless radio interface provided by the wireless communications network, the method comprising
   transmitting, to the communications device, signals on one or more downlink channels, each of the downlink channels being within one of a plurality of downlink transmission occasions, and
   receiving, from the communications device, an uplink control channel comprising an acknowledgement number indication, wherein the acknowledgement number indication indicates the number of the downlink transmission occasions within which the communications device has successfully received the signals on one of the downlink channels.
Paragraph 31. A method according to Paragraph 30, wherein the downlink transmission occasions are indicated by Downlink Control Information, DCI, transmitted by the infrastructure equipment to the communications device.
Paragraph 32. A method according to Paragraph 30 or Paragraph 31, wherein the downlink transmission occasions are Semi-Persistent Scheduling, SPS, resource instances forming an SPS group, wherein the SPS resource instances are periodically located in a plurality of downlink resource units of the wireless radio interface.
Paragraph 33. A method according to Paragraph 32, comprising
   transmitting Radio Resource Control, RRC, signalling to the communications device,
   wherein the RRC signalling indicates the plurality of SPS instances that form the SPS group.
Paragraph 34. A method according to Paragraph 32 or Paragraph 33, comprising
   transmitting a dynamic indication to the communications device,
   wherein the dynamic indication indicates the plurality of SPS instances that form the SPS group.
Paragraph 35. A method according to Paragraph 34, comprising
   transmitting, to the communications device, an activation DCI indicating that one or more of the SPS resource instances are activated,
   wherein a field of the activation DCI comprises the dynamic indication.
Paragraph 36. A method according to Paragraph 35, wherein the field of the activation DCI is a new field which is dedicated to the purpose of carrying the dynamic indication.
Paragraph 37. A method according to Paragraph 36, wherein the new field indicates an identifier of the SPS group for each of the SPS resource instances.
Paragraph 38. A method according to any of Paragraphs 35 to 37, wherein the field of the activation DCI is an existing field which is additionally used to carry the dynamic indication.
Paragraph 39. A method according to Paragraph 38, wherein the existing field indicates, for each of the SPS resource instances, a resource unit of the wireless radio interface in which the uplink control channel should be transmitted.
Paragraph 40. A method according to any of Paragraphs 32 to 39, comprising
   transmitting, within one of the transmitted downlink channels, a Medium Access Control, MAC, Control Element, CE,
   wherein the MAC CE indicates the plurality of SPS instances that form the SPS group.
Paragraph 41. A method according to any of Paragraphs 30 to 40, comprising
   transmitting RRC signalling to the communications device, and
   determining, based on the RRC signalling, the plurality of downlink transmission occasions.
Paragraph 42. A method according to any of Paragraphs 30 to 41, comprising
   transmitting a dynamic indication to the communications device, and
   determining, based on the dynamic indication, the plurality of downlink transmission occasions.
Paragraph 43. A method according to any of Paragraphs 30 to 42, comprising
   transmitting, within one of the transmitted downlink channels, a Medium Access Control, MAC, Control Element, CE,
   wherein the MAC CE indicates the plurality of downlink transmission occasions.
Paragraph 44. A method according to any of Paragraphs 30 to 43, wherein the acknowledgement number indication is indicated by a cyclic shift amount used for the transmission of the uplink control channel
Paragraph 45. A method according to Paragraph 44, wherein one or more of the cyclic shift amounts indicate more than one number of the downlink transmission occasions within which the communications device determines that the signals were successfully received on one of the downlink channels.
Paragraph 46. A method according to any of Paragraphs 30 to 45, wherein the acknowledgement number indication indicates one of a plurality of sets of acknowledgement numbers.
Paragraph 47. A method according to Paragraph 46, wherein the indicated set of acknowledgement numbers is indicated by a scrambling code used for the transmission of the uplink control channel.
Paragraph 48. A method according to Paragraph 46 or Paragraph 47, wherein the indicated set of acknowledgement numbers is indicated by a set of resources of the wireless radio interface used for the transmission of the uplink control channel
Paragraph 49. A method according to any of Paragraphs 46 to 48, wherein the acknowledgement number indication indicates in one or more bits, from within the indicated set of acknowledgement numbers, the number of the downlink transmission occasions within which the communications device determines that the signals were successfully received on one of the downlink channels.
Paragraph 50. A method according to any of Paragraphs 30 to 49, wherein the acknowledgement number indication indicates in one or more bits, the number of the downlink transmission occasions within which the communications device determines that the signals were successfully received on one of the downlink channels.
Paragraph 51. A method according to Paragraph 50, wherein one or more configurations of the one or more bits indicates more than one number of the downlink transmission occasions within which the communications device determines that the signals were successfully received on one of the downlink channels.
Paragraph 52. A method according to any of Paragraphs 30 to 51, comprising
   receiving, from the communications device, the uplink control channel comprising the acknowledgement number indication only when the communications device determines that transmitting the acknowledgement number indication is enabled.
Paragraph 53. A method according to Paragraph 52, comprising
   receiving, from the communications device for each of the downlink transmission occasions when the communications device determines that transmitting the acknowledgement number indication is disabled, an indication of whether signals were successfully received on one of the downlink channels.
Paragraph 54. A method according to Paragraph 52 or Paragraph 53, comprising
   transmitting RRC signalling to the communications device,
   wherein the RRC signalling indicates whether transmitting the acknowledgement number indication is enabled or disabled.
Paragraph 55. A method according to any of Paragraphs 52 to 54, wherein the downlink transmission occasions are SPS resource instances forming an SPS group, wherein the SPS resource instances are periodically located in a plurality of downlink resource units of the wireless radio interface, and wherein the method comprises
   transmitting, to the communications device, an activation DCI indicating that one or more of the SPS resource instances are activated,
   wherein the activation DCI indicates whether transmitting the acknowledgement number indication is enabled or disabled.
Paragraph 56. A method according to any of Paragraphs 52 to 55, comprising
   wherein whether or not the number of the downlink transmission occasions exceeds a threshold number indicates whether transmitting the acknowledgement number indication is enabled or disabled.
Paragraph 57. An infrastructure equipment forming part of a wireless communications network configured to transmit signals to and/or to receive signals from a communications device, the infrastructure equipment comprising
   transceiver circuitry configured to transmit signals and receive signals via a wireless radio interface provided by the wireless communications network, and
   controller circuitry configured in combination with the transceiver circuitry
   to transmit, to the communications device, signals on one or more downlink channels, each of the downlink channels being within one of a plurality of downlink transmission occasions, and
   to receive, from the communications device, an uplink control channel comprising an acknowledgement number indication, wherein the acknowledgement number indication indicates the number of the downlink transmission occasions within which the communications device has successfully received the signals on one of the downlink channels.
Paragraph 58. Circuitry for an infrastructure equipment forming part of a wireless communications network configured to transmit signals to and/or to receive signals from a communications device, the circuitry comprising
   transceiver circuitry configured to transmit signals and receive signals via a wireless radio interface provided by the wireless communications network, and
   controller circuitry configured in combination with the transceiver circuitry
   to transmit, to the communications device, signals on one or more downlink channels, each of the downlink channels being within one of a plurality of downlink transmission occasions, and
   to receive, from the communications device, an uplink control channel comprising an acknowledgement number indication, wherein the acknowledgement number indication indicates the number of the downlink transmission occasions within which the communications device has successfully received the signals on one of the downlink channels.
Paragraph 59. A method of operating an infrastructure equipment forming part of a wireless communications network configured to transmit signals to and/or to receive signals from a communications device via a wireless radio interface provided by the wireless communications network, the method comprising
   transmitting, to the communications device, signals on one or more downlink channels, each of the downlink channels being within one of a plurality of downlink transmission occasions,
   determining whether the number of downlink channels on which the signals are transmitted exceeds a threshold number, and, if the number of downlink channels on which the signals are transmitted exceeds the threshold number
   retransmitting, to the communications device, the signals on at least one of the downlink channels.
Paragraph 60. A method according to Paragraph 59, comprising
   determining that the infrastructure equipment is to receive, from the communications device, an uplink control channel comprising an acknowledgement number indication, wherein the acknowledgement number indication indicates the number of the downlink transmission occasions within which the communications device has successfully received the signals on one of the downlink channels,
   wherein the threshold number is equal to a maximum number of downlink transmission occasions that can be indicated by the acknowledgement number indication.
Paragraph 61. An infrastructure equipment forming part of a wireless communications network configured to transmit signals to and/or to receive signals from a communications device, the infrastructure equipment comprising
   transceiver circuitry configured to transmit signals and receive signals via a wireless radio interface provided by the wireless communications network, and
   controller circuitry configured in combination with the transceiver circuitry
   to transmit, to the communications device, signals on one or more downlink channels, each of the downlink channels being within one of a plurality of downlink transmission occasions,
   to determine whether the number of downlink channels on which the signals are transmitted exceeds a threshold number, and, if the number of downlink channels on which the signals are transmitted exceeds the threshold number
   to retransmit, to the communications device, the signals on at least one of the downlink channels.
Paragraph 62. Circuitry for an infrastructure equipment forming part of a wireless communications network configured to transmit signals to and/or to receive signals from a communications device, the circuitry comprising
   transceiver circuitry configured to transmit signals and receive signals via a wireless radio interface provided by the wireless communications network, and
   controller circuitry configured in combination with the transceiver circuitry
   to transmit, to the communications device, signals on one or more downlink channels, each of the downlink channels being within one of a plurality of downlink transmission occasions,
   to determine whether the number of downlink channels on which the signals are transmitted exceeds a threshold number, and, if the number of downlink channels on which the signals are transmitted exceeds the threshold number
   to retransmit, to the communications device, the signals on at least one of the downlink channels.
Paragraph 63. A method of operating a communications device configured to transmit signals to and/or to receive signals from a wireless communications network via a wireless radio interface provided by the wireless communications network, the method comprising
   receiving, from the wireless communications network, signals on one or more downlink channels, each of the downlink channels being within one of a plurality of downlink transmission occasions,
   determining, for each of the downlink channels, whether or not the signals have been successfully received by the communications device, and
   receiving, from the wireless communications network, an indication of the number of the one or more downlink channels on which the signals either have been or will be received.
Paragraph 64. A method according to Paragraph 63, wherein, if the number of the downlink transmission occasions within which the communications device determines that the signals were successfully received on one of the downlink channels is the same as the indicated number of the one or more downlink channels on which the signals either have been or will be received, the method comprises
   transmitting, to the wireless communications network, an uplink control channel comprising a positive acknowledgement.
Paragraph 65. A method according to Paragraph 63 or Paragraph 64, wherein, if the number of the downlink transmission occasions within which the communications device determines that the signals were successfully received on one of the downlink channels is not the same as the indicated number of the one or more downlink channels on which the signals either have been or will be received, the method comprises
   transmitting, to the wireless communications network, an uplink control channel comprising a negative acknowledgement.
Paragraph 66. A method according to any of Paragraphs 63 to 65, wherein, if the number of the downlink transmission occasions within which the communications device determines that the signals were successfully received on one of the downlink channels is not the same as the indicated number of the one or more downlink channels on which the signals either have been or will be received, the method comprises
   determining that the communications device should not transmit, to the wireless communications network, an uplink control channel comprising a positive acknowledgement.
Paragraph 67. A communications device configured to transmit signals to and/or to receive signals from a wireless communications network, the communications device comprising
   transceiver circuitry configured to transmit signals and receive signals via a wireless radio interface provided by the wireless communications network, and
   controller circuitry configured in combination with the transceiver circuitry
   to receive, from the wireless communications network, signals on one or more downlink channels, each of the downlink channels being within one of a plurality of downlink transmission occasions,
   to determine, for each of the downlink channels, whether or not the signals have been successfully received by the communications device, and
   to receive, from the wireless communications network, an indication of the number of the one or more downlink channels on which the signals either have been or will be received.
Paragraph 68. Circuitry for a communications device configured to transmit signals to and/or to receive signals from a wireless communications network, the circuitry comprising
   transceiver circuitry configured to transmit signals and receive signals via a wireless radio interface provided by the wireless communications network, and
   controller circuitry configured in combination with the transceiver circuitry
   to receive, from the wireless communications network, signals on one or more downlink channels, each of the downlink channels being within one of a plurality of downlink transmission occasions,
   to determine, for each of the downlink channels, whether or not the signals have been successfully received by the communications device, and
   to receive, from the wireless communications network, an indication of the number of the one or more downlink channels on which the signals either have been or will be received.
Paragraph 69. A method of operating an infrastructure equipment forming part of a wireless communications network configured to transmit signals to and/or to receive signals from a communications device via a wireless radio interface provided by the wireless communications network, the method comprising
   transmitting, to the communications device, signals on one or more downlink channels, each of the downlink channels being within one of a plurality of downlink transmission occasions, and
   transmitting, to the communications device, an indication of the number of the one or more downlink channels on which the signals either have been or will be transmitted.
Paragraph 70. A method according to Paragraph 69, wherein, if the number of the downlink transmission occasions within which the communications device determines that the signals were successfully received on one of the downlink channels is the same as the indicated number of the one or more downlink channels on which the signals either have been or will be transmitted, the method comprises
   receiving, from the communications device, an uplink control channel comprising a positive acknowledgement.
Paragraph 71. A method according to Paragraph 69 or 70, wherein, if the number of the downlink transmission occasions within which the communications device determines that the signals were successfully received on one of the downlink channels is not the same as the indicated number of the one or more downlink channels on which the signals either have been or will be transmitted, the method comprises
   receiving, from the communications device, an uplink control channel comprising a negative acknowledgement.
Paragraph 72. A method according to any of Paragraphs 69 to 71, wherein, if the number of the downlink transmission occasions within which the communications device determines that the signals were successfully received on one of the downlink channels is not the same as the indicated number of the one or more downlink channels on which the signals either have been or will be transmitted, the method comprises
   detecting that no uplink control channel comprising a positive acknowledgement has been received from the communications device, an uplink control channel
Paragraph 73. An infrastructure equipment forming part of a wireless communications network configured to transmit signals to and/or to receive signals from a communications device, the infrastructure equipment comprising
   transceiver circuitry configured to transmit signals and receive signals via a wireless radio interface provided by the wireless communications network, and
   controller circuitry configured in combination with the transceiver circuitry
   to transmit, to the communications device, signals on one or more downlink channels, each of the downlink channels being within one of a plurality of downlink transmission occasions, and
   to transmit, to the communications device, an indication of the number of the one or more downlink channels on which the signals either have been or will be transmitted.
Paragraph 74. Circuitry for an infrastructure equipment forming part of a wireless communications network configured to transmit signals to and/or to receive signals from a communications device, the circuitry comprising
   transceiver circuitry configured to transmit signals and receive signals via a wireless radio interface provided by the wireless communications network, and
   controller circuitry configured in combination with the transceiver circuitry
   to transmit, to the communications device, signals on one or more downlink channels, each of the downlink channels being within one of a plurality of downlink transmission occasions, and
   to transmit, to the communications device, an indication of the number of the one or more downlink channels on which the signals either have been or will be transmitted.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, third Generation Partnership Project, v14.3.0.
[3] RP-190726, “Physical layer enhancements for NR ultra-reliable and low latency communication (URLLC)”, Huawei, HiSilicon, RAN #83.
[4] RP-201310, “Revised WID: Enhanced Industrial Internet of Things (IoT) and ultra-reliable and low latency communication (URLLC) support for NR,” Nokia, Nokia Shanghai Bell, RAN #88e.
[5] R1-2007655, “HARQ-ACK enhancements for Rel-17 URLLC,” vivo, RAN WG1#103-e.
[6] R1-2008984, “Discussion on prioritized UE HARQ feedback enhancements for URLLC/IIoT,” Intel Corporation, RAN WG1#103-e.

1. A method of operating a communications device configured to transmit signals to and/or to receive signals from a wireless communications network via a wireless radio interface provided by the wireless communications network, the method comprising
receiving, from the wireless communications network, signals on one or more downlink channels, each of the downlink channels being within one of a plurality of downlink transmission occasions,
determining, for each of the downlink channels, whether or not the signals have been successfully received by the communications device, and
transmitting, to the wireless communications network, an uplink control channel comprising an acknowledgement number indication, wherein the acknowledgement number indication indicates the number of the downlink transmission occasions within which the communications device determines that the signals were successfully received on one of the downlink channels.

2. A method according to claim 1, wherein the downlink transmission occasions are indicated by Downlink Control Information, DCI, received by the communications device from the wireless communications network.

3. A method according to claim 1, wherein the downlink transmission occasions are Semi-Persistent Scheduling, SPS, resource instances forming an SPS group, wherein the SPS resource instances are periodically located in a plurality of downlink resource units of the wireless radio interface.

4. A method according to claim 3, comprising
receiving Radio Resource Control, RRC, signalling from the wireless communications network, and
determining, based on the RRC signalling, the plurality of SPS instances that form the SPS group.

5. A method according to claim 3, comprising
receiving a dynamic indication from the wireless communications network, and
determining, based on the dynamic indication, the plurality of SPS instances that form the SPS group.

6. A method according to claim 5, comprising
receiving, from the wireless communications network, an activation DCI indicating that one or more of the SPS resource instances are activated,
wherein a field of the activation DCI comprises the dynamic indication.

7. A method according to claim 6, wherein the field of the activation DCI is a new field which is dedicated to the purpose of carrying the dynamic indication.

8. A method according to claim 7, wherein the new field indicates an identifier of the SPS group for each of the SPS resource instances.

9. A method according to claim 6, wherein the field of the activation DCI is an existing field which is additionally used to carry the dynamic indication.

10. A method according to claim 9, wherein the existing field indicates, for each of the SPS resource instances, a resource unit of the wireless radio interface in which the uplink control channel should be transmitted, and wherein the method comprises
determining that the SPS group is formed by the plurality of SPS instances when the existing field indicates that the uplink control channel should be transmitted in the same resource unit for all of the plurality of SPS instances.

11. A method according to claim 3, comprising
determining, based on a Medium Access Control, MAC, Control Element, CE, within one of the received downlink channels, the plurality of SPS instances that form the SPS group.

12. A method according to claim 1, comprising
receiving RRC signalling from the wireless communications network, and
determining, based on the RRC signalling, the plurality of downlink transmission occasions.

13. A method according to claim 1, comprising
receiving a dynamic indication from the wireless communications network, and
determining, based on the dynamic indication, the plurality of downlink transmission occasions.

14. A method according to claim 1, comprising
determining, based on a Medium Access Control, MAC, Control Element, CE, within one of the received downlink channels, the plurality of downlink transmission occasions.

15. A method according to claim 1, wherein the acknowledgement number indication is indicated by a cyclic shift amount used for the transmission of the uplink control channel.

16. A method according to claim 15, wherein one or more of the cyclic shift amounts indicate more than one number of the downlink transmission occasions within which the communications device determines that the signals were successfully received on one of the downlink channels.

17. A method according to claim 1, wherein the acknowledgement number indication indicates one of a plurality of sets of acknowledgement numbers.

18.-20. (canceled)

21. A method according to claim 1, wherein the acknowledgement number indication indicates in one or more bits, the number of the downlink transmission occasions within which the communications device determines that the signals were successfully received on one of the downlink channels.

22.-27. (canceled)

28. A communications device configured to transmit signals to and/or to receive signals from a wireless communications network, the communications device comprising
transceiver circuitry configured to transmit signals and receive signals via a wireless radio interface provided by the wireless communications network, and
controller circuitry configured in combination with the transceiver circuitry
to receive, from the wireless communications network, signals on one or more downlink channels, each of the downlink channels being within one of a plurality of downlink transmission occasions,
to determine, for each of the downlink channels, whether or not the signals have been successfully received by the communications device, and
to transmit, to the wireless communications network, an uplink control channel comprising an acknowledgement number indication, wherein the acknowledgement number indication indicates the number of the downlink transmission occasions within which the communications device determines that the signals were successfully received on one of the downlink channels.

29.-56. (canceled)

57. An infrastructure equipment forming part of a wireless communications network configured to transmit signals to and/or to receive signals from a communications device, the infrastructure equipment comprising
transceiver circuitry configured to transmit signals and receive signals via a wireless radio interface provided by the wireless communications network, and
controller circuitry configured in combination with the transceiver circuitry
to transmit, to the communications device, signals on one or more downlink channels, each of the downlink channels being within one of a plurality of downlink transmission occasions, and
to receive, from the communications device, an uplink control channel comprising an acknowledgement number indication, wherein the acknowledgement number indication indicates the number of the downlink transmission occasions within which the communications device has successfully received the signals on one of the downlink channels.

58.-74. (canceled)
